(19) United States
(12) Patent Application Publication
(10) Pub. No.: US 2011/0044070 A1
(43) Pub. Date: Feb. 24, 2011

(54) LIGHT SOURCE DEVICE

(75) Inventor: Koji Takahashi, Osaka-shi (JP)

Correspondence Address: MORRISON & FOERSTER LLP, 1650 TYSONS BOULEVARD, SUITE 400, MCLEAN, VA, 22102, US

(73) Assignee: Sharp Kabushiki Kaisha, Osaka-shi (JP)

(21) Appl. No.: 12/854,769

(22) Filed: Aug. 11, 2010

(30) Foreign Application Priority Data
Aug. 18, 2009 (JP) 2009-189132(P)
May 14, 2010 (JP) 2010-111938(P)

(51) Int. Cl. F21V 8/00; F21V 11/00; F21V 13/10

(52) U.S. Cl. 362/553; 362/231; 362/259

(57) ABSTRACT

A light source device includes a first semiconductor laser element that oscillates a first laser beam having a visible-region wavelength, a second semiconductor laser element that oscillates a second laser beam having a visible-region wavelength, and a light-scattering body that is irradiated with first laser beam and second laser beam to scatter first laser beam and second laser beam without changing the wavelengths. Because the wavelengths are not converted, first laser beam and second laser beam oscillated from first semiconductor laser element and second semiconductor laser element are emitted without generating energy losses of first laser beam and second laser beam.

This nonprovisional application is based on Japanese Patent Application No. 2009-189132 filed on Aug. 18, 2009 and No. 2010-111938 filed on May 14, 2010, with the Japan Patent Office, the entire contents of which are hereby incorporated by reference.

### BACKGROUND OF THE INVENTION

1. Field of the Invention

The present invention relates to a light source device in which a semiconductor laser element is used as a light source.

2. Description of the Background Art

A light source device in which a laser beam oscillated from a semiconductor laser element is used as the light source is proposed instead of various light source devices such as an incandescent lamp, a fluorescent light, and a discharge tube.

Japanese Patent Laying-Open No. 2008-043754 discloses a light emitting device including a semiconductor laser element (excitation light source), an optical fiber, and a wavelength conversion member. The wavelength conversion member includes a fluorescent material. The fluorescent material absorbs the laser beam applied from the semiconductor laser element. The fluorescent material that absorbs the laser beam converts a wavelength of the laser beam and emits illumination light having an arbitrary wavelength region (color).

Japanese Patent Laying-Open No. 2002-095634 discloses an endoscope apparatus including an excitation light source, a light guide, and a lighting lens. The lighting lens is provided at a leading end of the light guide. The light guide guides the excitation light oscillated from the excitation light source to the lighting lens. The lighting lens is inserted in a human body along with the light guide, and an arbitrary diseased site is illuminated with the guided excitation light.

Japanese Patent Laying-Open No. 2006-352105 discloses an optical transmission device including an excitation light source and a light-scattering member. The excitation light source is covered with the light-scattering member. The light-scattering member enlarges a diameter of the excitation light oscillated from the excitation light source using a light-scattering function of the light-scattering member.

According to the light emitting device disclosed in Japanese Patent Laying-Open No. 2008-043754, the fluorescent material that absorbs the laser beam emits the light having the arbitrary wavelength region. Because the fluorescent material that absorbs the laser beam converts the wavelength of the laser beam, energy of the laser beam is lost (Stokes loss). In order to obtain desired luminance as the light source device, it is necessary that the semiconductor laser element oscillate the laser beam having the larger energy in consideration of the loss.

### SUMMARY OF THE INVENTION

An object of the present invention is to provide a light source device that can emit the laser beam, oscillated from the semiconductor laser element, without generating the energy loss of the laser beam.

Another object of the present invention is to provide a light source device that can easily collect the laser beam, oscillated from the semiconductor laser element, with relatively low attaching accuracy.

In accordance with a first aspect of the invention, a light source device includes: at least two semiconductor laser elements that oscillate laser beams having visible-region wavelengths; and a light-scattering body that is irradiated with the laser beams to scatter the laser beams without changing the wavelengths. The laser beams oscillated from at least the two semiconductor laser elements have different colors.

In the light source device in accordance with the first aspect of the invention, preferably the light-scattering body is directly irradiated with the laser beams oscillated from at least the two semiconductor laser elements.

Preferably the light source device in accordance with the first aspect of the invention further includes a package. At least the two semiconductor laser elements are mounted in the package, and the light-scattering body is configured to be integral with the package.

In the light source, preferably the package includes a window portion. A translucent member having translucency is attached to the window portion. The light-scattering body is disposed so as to come into close contact with the translucent member.

In the light source device in accordance with the first aspect of the invention, preferably the laser beams oscillated from at least the two semiconductor laser elements are converted into parallel rays, and the light-scattering body is irradiated with the parallel rays that are independent of each other.

Preferably the light source device in accordance with the first aspect of the invention further includes a combining member that combines the laser beams oscillated from at least the two semiconductor laser elements. The light-scattering body is irradiated with the laser beams with being mutually combined by the combining member.

Preferably the light source device in accordance with the first aspect of the invention further includes a light guiding unit that guides the laser beams oscillated from at least the two semiconductor laser elements to the light-scattering body and irradiates the light-scattering body with the guided laser beam.

In the light source device in accordance with the first aspect of the invention, preferably the light guiding unit that irradiates the light-scattering body with the guided laser beam is an optical fiber.

In the light source device in accordance with the first aspect of the invention, preferably an outer shape of the light guiding unit is formed into a substantially truncated pyramid, the light guiding unit is a light guide member that includes a light incident surface and a light outgoing surface whose area is smaller than that of the light incident surface. The light guide member is made of a material that is transparent with respect to visible light. At least the two semiconductor laser elements are disposed on a side of the light incident surface, and the light-scattering body is disposed on a side of the light outgoing surface.

In the light source device in accordance with the first aspect of the invention, preferably at least the two semiconductor laser elements are disposed such that the laser beams oscillated from at least the two semiconductor laser elements are guided from the side of the light incident surface toward the side of the light outgoing surface while total internal reflection is repeated in the light guide member.

In the light source device in accordance with the first aspect of the invention, preferably at least the two semiconductor laser elements are disposed such that optical axes of the laser beams oscillated from at least the two semiconductor laser elements are oriented toward the light-scattering body.

In the light source device in accordance with the first aspect of the invention, preferably the light-scattering body is configured to be integral with the light guide member.

In the light source device in accordance with the first aspect of the invention, preferably the light-scattering body includes a base material made of a transparent resin or glass material and transparent light-scattering particles that are dispersed in the base material, the transparent light-scattering particles having a refractive index different from that of the base material.

In the light source device in accordance with the first aspect of the invention, preferably the laser beams that are scattered by the light-scattering body without changing the wavelengths are mixed to form white light.

In the light source device in accordance with the first aspect of the invention, preferably at least the two semiconductor laser elements are at least three semiconductor laser elements in order to form the white light, and at least the three semiconductor laser elements include: the semiconductor laser element that oscillates the laser beam of blue; the semiconductor laser element that oscillates the laser beam of red; and the semiconductor laser element that oscillates the laser beam of green.

In the light source device in accordance with the first aspect of the invention, preferably, in order to form the white light, at least the two semiconductor laser elements include: the semiconductor laser element that oscillates the laser beam of yellow; and the semiconductor laser element that oscillates the laser beam of blue.

In the light source device in accordance with the first aspect of the invention, preferably, in order to form the white light, at least the two semiconductor laser elements include: the semiconductor laser element that oscillates the laser beam of red; and the semiconductor laser element that oscillates the laser beam of blue-green.

Preferably the light source device in accordance with the first aspect of the invention further includes a substantially-concave-shaped reflecting mirror that has a focal point. The light-scattering body is disposed at a position of the focal point.

In the light source, preferably the reflecting mirror includes an opening. The light-scattering body is irradiated with the laser beams oscillated from at least the two semiconductor laser elements through the opening.

In accordance with a second aspect of the invention, a light source device includes: a light guide member and a semiconductor laser element. The light guide member has an outer shape formed into a substantially truncated pyramid. The light guide member includes a light incident surface and a light outgoing surface whose area is smaller than that of the light incident surface. The light guide member being made of a material that is transparent with respect to a laser beam. The semiconductor laser element oscillates the laser beam, the laser beam being disposed such that the laser beam is oriented from a side of the light incident surface toward an inside of the light guide member. The laser beam oscillated from the semiconductor laser element is collected on a side of the light outgoing surface.

In the light source device in accordance with the second aspect of the invention, preferably the semiconductor laser element is disposed such that the laser beam oscillated from the semiconductor laser element is guided from the side of the light incident surface toward the side of the light outgoing surface while total internal reflection is repeated in the light guide member.

In the light source device in accordance with the first aspect of the invention, preferably the semiconductor laser element is disposed such that an optical axis of the laser beam oscillated from the semiconductor laser element is oriented toward the light outgoing surface.

Each term in the invention is defined as follows. “Laser beam having a visible-region wavelength” means that the laser beam has the wavelength of about 380 nm to about 780 nm.

“Blue laser beam” means that the laser beam has the wavelength of about 430 nm to about 490 nm. “Blue-green laser beam” means that the laser beam has the wavelength of about 490 nm to about 510 nm. “Green laser beam” means that the laser beam has the wavelength of about 510 nm to about 570 nm. “Yellow laser beam” means that the laser beam has the wavelength of about 570 nm to about 590 nm. “Red laser beam” means that the laser beam has the wavelength of about 590 nm to about 780 nm.

The laser beam having the wavelength of about 380 nm to about 430 nm means “blue-violet laser beam”.

Accordingly, the invention can provide the light source device that can emit the laser beam, oscillated from the semiconductor laser element, without generating the energy loss of the laser beam.

The foregoing and other objects, features, aspects, and advantages of the present invention will become more apparent from the following detailed description of the present invention when taken in conjunction with the accompanying drawings.

### BRIEF DESCRIPTION OF THE DRAWINGS

FIG. 1 schematically illustrates a configuration of a light source device according to a first embodiment of the invention in which a laser beam is applied from an outgoing port side using a reflecting mirror.

FIG. 2 schematically illustrates a configuration according to a second embodiment of the invention in which a package is used.

FIG. 3 schematically illustrates a configuration of a light source device according to a third embodiment of the invention in which the package and the reflecting mirror are used.

FIG. 4 schematically illustrates a configuration of a light source device according to a fourth embodiment of the invention.

FIG. 5 schematically illustrates a configuration of a light source device according to a fifth embodiment of the invention in which a combining member is used.

FIG. 6 schematically illustrates a configuration of a light source device according to a sixth embodiment of the invention in which a light guiding unit is used.

FIG. 7 schematically illustrates a configuration of a light source device according to a seventh embodiment of the invention in which the laser beam is applied from a back surface side using the reflecting mirror.

FIG. 8 schematically illustrates a configuration of a light source device according to an eighth embodiment of the invention in which the reflecting mirror and the combining member are used.

FIG. 9 schematically illustrates a configuration of a light source device according to a ninth embodiment of the invention in which the laser beam is applied from the back surface side using the reflecting mirror and the light guiding unit.

FIG. 10 schematically illustrates a configuration of a light source device according to a tenth embodiment of the invention in which the laser beam is applied from the outgoing port side using the reflecting mirror and the light guiding unit.

FIG. 11 is a perspective view schematically illustrating a configuration of a light source device according to an eleventh embodiment of the invention in which the light guide member is used.

FIG. 12 is a sectional view taken on a line XII-XII of FIG. 11.

FIG. 13 is a sectional view schematically illustrating a light source device according to a twelfth embodiment of the invention in which semiconductor laser elements are disposed such that an optical axis of each laser beam is oriented toward a light-scattering body.

FIG. 14 is a sectional view schematically illustrating a light source device according to a thirteenth embodiment of the invention in which the light-scattering body is integral with a light outgoing surface side of the light guide member.

FIG. 15 is a sectional view schematically illustrating a configuration of a light source device according to a fourteenth embodiment of the invention in which the light guide member and the reflecting mirror are used.

FIG. 16 is a sectional view schematically illustrating a configuration of a light source device according to a fifteenth embodiment of the invention in which the package and the light guide member are used.

FIG. 17 is a sectional view schematically illustrating a configuration of a light source device according to a sixteenth embodiment of the invention in which the package, the light guide member, and the reflecting mirror are used.

FIG. 18 is a sectional view schematically illustrating a light source device according to a seventeenth embodiment of the invention.

FIG. 19 is a sectional view schematically illustrating a light source device according to an eighteenth embodiment of the invention.

FIG. 20 is a sectional view schematically illustrating a light source device according to a nineteenth embodiment of the invention.

### DESCRIPTION OF THE PREFERRED EMBODIMENTS

Light source devices according to exemplary embodiments of the invention will be described below with reference to the drawings. When the number of pieces and quantity are referred to in the following embodiments, the invention is not limited to the number of pieces and quantity unless otherwise noted. The identical component is designated by the identical numeral, and occasionally the overlapping description is not repeated. It is noted that configurations of the following embodiments are combined unless in particular limitations.

### First Embodiment

### Configuration

A light source device 100 according to a first embodiment of the invention will be described with reference to FIG. 1. Light source device 100 includes a first semiconductor laser element 10A, a second semiconductor laser element 10B, a light-scattering body 30, and a reflecting mirror 40 having a substantially concave shape.

(Semiconductor Laser Element)

First semiconductor laser element 10A oscillates a first laser beam 11A having a visible-region wavelength. Second semiconductor laser element 10B oscillates a second laser beam 11B having a visible-region wavelength. First semiconductor laser element 10A may oscillate first laser beam 11A having a blue wavelength, and second semiconductor laser element 10B may oscillate second laser beam 11B having a yellow wavelength that is different from that of first laser beam 11A. A color combination is not limited to the blue and the yellow. There is no particular limitation to a kind and a configuration of the oscillated laser beam.

First semiconductor laser element 10A applies first laser beam 11A toward light-scattering body 30. Second semiconductor laser element 10B applies second laser beam 11B toward light-scattering body 30. Light-scattering body 30 is irradiated with first laser beam 11A and second laser beam 11B, which are independent of each other. In the first embodiment, light-scattering body 30 is directly irradiated with laser beams 11A and 11B (without passing through a collimator lens or a light guide member).

(Light-Scattering Body 30)

Light-scattering body 30 will be described based on first laser beam 11A. The same holds true for second laser beam 11B. Light-scattering body 30 scatters first laser beam 11A without changing the wavelength. “Without changing the wavelength” means that light-scattering body 30 scatters first laser beam 11A while the wavelength of first laser beam 11A is not changed at all, and does not include the case in which the wavelength of the laser beam is converted by a fluorescent material.

In order to prevent heat generation of light-scattering body 30 due to applied first laser beam 11A, light source device 100 may further include a temperature controller that maintains light-scattering body 30 at a constant temperature. For example, the temperature controller is a cooling fan.

Light-scattering body 30 may include a base material made of a transparent resin or glass material and transparent light-scattering particles that are dispersed in the base material and has a refractive index different from that of the base material. For example, the resin is silicone. For example, the light-scattering particles are TiO₂ particles.

As to dimensions of light-scattering body 30, light-scattering body 30 can be formed into a sphere having a diameter of about 1 mm to about 10 mm or a cube having a side of about 1 mm to about 10 mm.

The side of light-scattering body 30, which is irradiated with first laser beam 11A, may be formed into a planar shape having a predetermined area. Light-scattering body 30 is irradiated with first laser beam 11A while first laser beam 11A spreads with a predetermined width, thereby decreasing light density per unit area of first laser beam 11A with which light-scattering body 30 is irradiated.

When a distance from first semiconductor laser element 10A to light-scattering body 30 is sufficiently short, light-scattering body 30 is sufficiently irradiated with first laser beam 11A before first laser beam 11A spreads. Light-scattering body 30 on the side irradiated with first laser beam 11A can be formed into an arbitrary shape having a predetermined sectional area where light-scattering body 30 is sufficiently irradiated with first laser beam 11A.

Light-scattering body 30 on the side irradiated with first laser beam 11A is formed into the planar shape having the predetermined area, so that the light density of first laser beam 11A can be decreased and light-scattering body 30 can be prevented from generating the heat caused by first laser beam 11A. Light-scattering body 30 that is prevented from generating the heat can scatter first laser beam 11A, with which light-scattering body 30 is sufficiently irradiated, without losing energy of first laser beam 11A.

(Laser Beam)

When scattered by light-scattering body 30, first laser beam 11A and second laser beam 11B may be mixed to form a laser beam having a color with which an irradiation object can visibly be recognized. For example, in order to form a white laser beam, light source device 100 may include a semiconductor laser element that oscillates a blue laser beam and a semiconductor laser element that oscillates a yellow laser beam. In order to form the white laser beam, light source device 100 may include a semiconductor laser element that oscillates a red laser beam and a semiconductor laser element that oscillates a blue-green laser beam.

(Reflecting Mirror 40)

Reflecting mirror 40 may have a focal point. Light-scattering body 30 may be disposed so as to include the focal point of reflecting mirror 40. Floodlight efficiency of reflecting mirror 40 is enhanced when light-scattering body 30 is disposed so as to include the focal point of reflecting mirror 40.

First semiconductor laser element 10A applies first laser beam 11A toward light-scattering body 30. Second semiconductor laser element 10B applies second laser beam 11B toward light-scattering body 30.

Light-scattering body 30 is irradiated with first laser beam 11A and second laser beam 11B from the side (the right side of reflecting mirror 40 in FIG. 1) on which an outgoing port of reflecting mirror 40 exists.

Light-scattering body 30 is irradiated with first laser beam 11A through a first opening 41A2 provided in reflecting mirror 40, and light-scattering body 30 is irradiated with second laser beam 11B through a second opening 41B2 provided in reflecting mirror 40.

For example, reflecting mirror 40 is a glass concave mirror whose surface is coated with aluminum. When scattered first laser beam 11A and second laser beam 11B are mixed to form the white light, reflecting mirror 40 having high reflectance with respect to the white light may be used. For example, reflecting mirror 40 is a parabolic concave mirror having a radius of about 30 mm and a depth of about 50 mm.

(Action and Effect)

The action and effect of light source device 100 of the first embodiment will be described below. Light source device 100 includes first semiconductor laser element 10A and second semiconductor laser element 10B. First semiconductor laser element 10A and second semiconductor laser element 10B individually oscillate the laser beams having arbitrary colors, and the oscillated laser beams are mixed by light-scattering body 30. Light source device 100 can be used as a light source that emits light having arbitrary color.

First laser beam 11A and second laser beam 11B, with which light-scattering body 30 is irradiated, repeat multiple scattering in light-scattering body 30. First laser beam 11A and second laser beam 11B, which repeat the multiple scattering, are combined in light-scattering body 30 and scattered as scattering light beams 31A to 31F that travel radially in arbitrary directions from a surface of light-scattering body 30. Light-scattering body 30 forms a light source that emits scattering light beams 31A to 31F.

First laser beam 11A and second laser beam 11B have high coherency before the repetition of the multiple scattering. After the repetition of the multiple scattering, light-scattering body 30 emits scattering light beam 31A to 31F each of which coherency is sufficiently decreased. Because of the decreased coherency in first laser beam 11A and second laser beam 11B, light source device 100 can suppress generation of a stripe pattern caused by overlapping (light interference) of the laser beam. The coherency is decreased in first laser beam 11A and second laser beam 11B, and apparent dimensions of the light source are enlarged to dimensions of light-scattering body 30, so that light source device 100 can suppress a harmful influence of the laser beam on a human body (eyes).

Light source device 100 emits scattering light beams 31A to 31F while light-scattering body 30 does not convert the wavelengths of first laser beam 11A and second laser beam 11B. Even if scattering light beams 31A to 31F are emitted, the energy is not lost in first laser beam 11A and second laser beam 11B. Light source device 100 can emit scattering light beams 31A to 31F without generating the energy losses of first laser beam 11A and second laser beam 11B, which are oscillated from first semiconductor laser element 10A and second semiconductor laser element 10B. In order to obtain desired luminance, light source device 100 can be produced so as to emit a laser beam having energy smaller than that of a light emitting device including a fluorescent material.

Although the two semiconductor laser elements are used in the first embodiment, at least two semiconductor laser elements that oscillate laser beams having different colors can also be configured.

In scattering light beams 31A to 31F, scattering light beams 31A to 31C are emitted toward an opposite direction (from the left toward the right in FIG. 1) to reflecting mirror 40. In scattering light beams 31A to 31F, scattering light beams 31D to 31F emitted toward reflecting mirror 40 (emitted from the right toward the left in FIG. 1) are reflected by reflecting mirror 40. Scattering light beams 31A to 31C and reflected scattering light beams 31D and 31F are further combined to form combined light beams 32A to 32C having directivity, and combined light beams 32A to 32C are emitted.

Light source device 100 can emit combined light beams 32A to 32C having the desired directivity or luminance by designing reflecting mirror 40 into the desired dimensions or shape. Light source device 100 can emit combined light beams 32A to 32C having the desired directivity or luminance and high floodlight efficiency by the design of reflecting mirror 40. Light source device 100 can be used as the light source that emits the light beams having the desired directivity or luminance by emitted combined light beams 32A to 32C.

According to light source device 100, the energy losses of first laser beam 11A and second laser beam 11B are not generated even if scattering light beams 31D to 31F are reflected by reflecting mirror 40. Even if the energy losses of first laser beam 11A and second laser beam 11B are generated by reflecting mirror 40, an amount of energy loss is extremely low compared with an amount of energy loss in which the light emitting device including the fluorescent material converts the wavelength.

Because the energy losses of first laser beam 11A and second laser beam 11B are not generated by reflecting mirror 40, the energy losses of first laser beam 11A and second laser beam 11B are not generated even if light-scattering body 30 is irradiated with first laser beam 11A and second laser beam 11B to emit combined light beams 32A to 32C. Light source device 100 can emit combined light beams 32A to 32C without generating the energy losses of first laser beam 11A and second laser beam 11B, which are oscillated from first semiconductor laser element 10A and second semiconductor laser element 10B.

For example, in considering first laser beam 11A, light-scattering body 30 is irradiated with first laser beam 11A while first laser beam 11A spreads toward light-scattering body 30 with a predetermined width (width between a laser beam 11Aa and a laser beam 11Ab). Similarly light-scattering body 30 is irradiated with second laser beam 11B while second laser beam 11B spreads toward light-scattering body 30 with a predetermined width (width between a laser beam 11Ba and a laser beam 11Bb). First semiconductor laser element 10A and second semiconductor laser element 10B are disposed such that a distance between light-scattering body 30 and each of first semiconductor laser element 10A and second semiconductor laser element 10B becomes sufficiently short, which allows light-scattering body 30 to be sufficiently irradiated with first laser beam 11A and second laser beam 11B before first laser beam 11A and second laser beam 11B spread.

In light-scattering body 30, the side irradiated with first laser beam 11A and second laser beam 11B may be formed into an arbitrary shape having a predetermined sectional area. Light-scattering body 30 having the planar shape is illustrated in FIG. 1. The light density of first laser beam 11A and second laser beam 11B is decreased, and the heat generation of light-scattering body 30 caused by first laser beam 11A and second laser beam 11B is suppressed, so that light-scattering body 30 whose heat generation is suppressed can scatter first laser beam 11A and second laser beam 11B, with which light-scattering body 30 is sufficiently irradiated, without generating the energy losses of first laser beam 11A and second laser beam 11B.

Because the light density of first laser beam 11A and second laser beam 11B is decreased, degradation of light-scattering body 30 can be suppressed. In light-scattering body 30, the scattering light beam is most efficiently taken out to the outside from a region irradiated with first laser beam 11A and second laser beam 11B, so that the scattering light beam can efficiently be taken out to the side on which the outgoing port of reflecting mirror 40 exists by irradiating light-scattering body 30 with first laser beam 11A and second laser beam 11B from the side on which the outgoing port exists.

### Second Embodiment

### Configuration

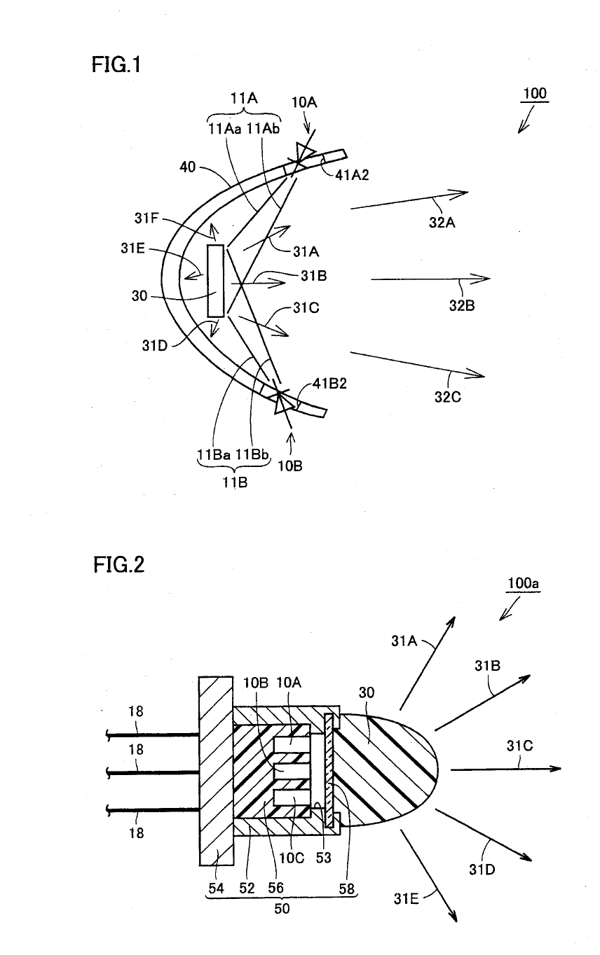

A light source device 100a according to a second embodiment of the invention will be described with reference to FIG. 2. Light source device 100a includes first semiconductor laser element 10A, second semiconductor laser element 10B, and a third semiconductor laser element 10C, light-scattering body 30, and a package 50.

Similarly to the first embodiment, semiconductor laser elements 10A, 10B, and 10C oscillate laser beams having visible-region wavelengths. Semiconductor laser elements 10A, 10B, and 10C oscillate the laser beams whose wavelengths are different from one another.

Package 50 is formed into a box shape by a metallic cap 52, a base portion 54, a heatsink 56, and a glass 58 that is a translucent member having translucency. Glass 58 is attached to a window portion 53 that is provided in metallic cap 52 while opened in metallic cap 52. Semiconductor laser elements 10A, 10B, and 10C are mounted in package 50.

Semiconductor laser elements 10A, 10B, and 10C are mounted on copper or iron heatsink 56 with a solder material (not illustrated) interposed therebetween. Heatsink 56 on which semiconductor laser elements 10A, 10B, and 10C are mounted is sealed by metallic cap 52. Semiconductor laser elements 10A, 10B, and 10C may be mounted while a sub-mount material (such as SiC and AlN) that acts as a heat spreader is interposed between heatsink 56 and each of semiconductor laser elements 10A, 10B, and 10C.

Light-scattering body 30 is irradiated with the laser beams oscillated from semiconductor laser elements 10A, 10B, and 10C. In the second embodiment, light-scattering body 30 is directly irradiated with the laser beams oscillated from semiconductor laser elements 10A, 10B, and 10C (without passing through a collimator lens or a light guide member). Similarly to the first embodiment, light-scattering body 30 scatters the laser beams without changing the wavelength.

Light-scattering body 30 may be formed into a doom shape. Similarly to the first embodiment, light-scattering body 30 may include the base material made of the transparent resin or glass material and transparent light-scattering particles that are dispersed in the base material and has the refractive index different from that of the base material. For example, the resin is silicone. For example, the light-scattering particles are TiO₂ particles.

Light-scattering body 30 is integral with package 50. Light-scattering body 30 may be disposed on glass 58 so as to come close contact with glass 58.

A predetermined command is provided from the outside to each of semiconductor laser elements 10A, 10B, and 10C through a lead wire 18, which allows semiconductor laser elements 10A, 10B, and 10C to independently oscillate the laser beams. When scattered by light-scattering body 30, semiconductor laser elements 10A, 10B, and 10C may be mixed to form the laser beam having the color with which the irradiation object can visibly be recognized.

For example, in order to form the white laser beam, first semiconductor laser element 10A may oscillate the blue laser beam in light source device 100a. Second semiconductor laser element 10B may oscillate the red laser beam. Third semiconductor laser element 10C may oscillate the green laser beam. There is no limitation to the color combination. There is also no particular limitation to the kind or configuration of the oscillated laser beam.

For example, first semiconductor laser element 10A that oscillates the blue laser beam can be obtained by forming an AlGaInN material on a GaN substrate or a sapphire substrate. For example, first semiconductor laser element 10A that oscillates the blue laser beam oscillates the laser beam having the wavelength of about 445 nm.

For example, second semiconductor laser element 10B that oscillates the red laser beam can be obtained by forming an AlGaInP material on a GaAs substrate. For example, second semiconductor laser element 10B that oscillates the red laser beam oscillates the laser beam having the wavelength of about 635 nm.

For example, a semiconductor laser element that is made of an AlGaInN material and oscillates the green laser beam can be used as third semiconductor laser element 10C that oscillates the green laser beam. Third semiconductor laser element 10C that oscillates the green laser beam oscillates the laser beam having the wavelength of about 520 nm, for example. Although the semiconductor laser element that oscillates the green laser beam is currently in a research and development stage, the semiconductor laser element is scheduled for quantity production and sale at a market.

(Action and Effect)

The action and effect of light source device 100a of the second embodiment will be described below. In light source device 100a, semiconductor laser elements 10A, 10B, and 10C individually oscillate laser beams having arbitrary colors. The laser beams repeat the multiple scattering in light-scattering body 30. The laser beams that repeat the multiple scattering are combined in light-scattering body 30 to form scattering light beams 31A to 31E, and scattering light beams 31A to 31E are radially scattered toward arbitrary directions from the surface of light-scattering body 30. Light-scattering body 30 forms a light source that emits scattering light beams 31A to 31E.

Light source device 100a that emits scattering light beams 31A to 31E can be used in various applications. Specifically, the various applications include not only the light source for lighting but also a light source for image projection as substitution for an overhead projector lamp.

Each laser beam has the high coherency before the repetition of the multiple scattering. After the repetition of the multiple scattering, light-scattering body 30 emits scattering light beams 31A to 31F each of which the coherency is sufficiently decreased. Because of the decreased coherency of each laser beam, light source device 100a can suppress the generation of the stripe pattern caused by the overlapping (light interference) of the laser beam. The coherency is decreased in each laser beam, and the apparent dimensions of the light source are enlarged to the dimensions of light-scattering body 30, so that light source device 100a can suppress the harmful influence of the laser beam on the human body (eyes).

Because semiconductor laser elements 10A, 10B, and 10C are integrally formed by package 50, extremely small light source device 100a can be configured as a whole. Light source device 100a can simply be formed at low cost. Because package 50 and light-scattering body 30 are integral with each other, the laser beams oscillated from semiconductor laser elements 10A, 10B, and 10C does not go outside from package 50, thereby securing high safeness.

Light source device 100a emits scattering light beams 31A to 31E while light-scattering body 30 does not convert the wavelengths of the laser beams. Even if scattering light beams 31A to 31E are emitted, the energy is not lost in the laser beams. Light source device 100a can emit scattering light beams 31A to 31E without generating the energy losses of the laser beams oscillated from semiconductor laser elements 10A, 10B, and 10C. In order to obtain the desired luminance, light source device 100a can be produced so as to emit the laser beam having the energy smaller than that of the light emitting device including the fluorescent material.

Although the three semiconductor laser elements are used in the second embodiment, at least two semiconductor laser elements that oscillate laser beams having different colors can also be configured.

For example, for the configuration in which the two semiconductor laser elements are used, first semiconductor laser element 10A may oscillate the laser beam having the blue wavelength, and second semiconductor laser element 10B may oscillate the laser beam having the yellow wavelength. First semiconductor laser element 10A may oscillate the laser beam having the red wavelength, and second semiconductor laser element 10B may oscillate the laser beam having the blue-green wavelength.

### Third Embodiment

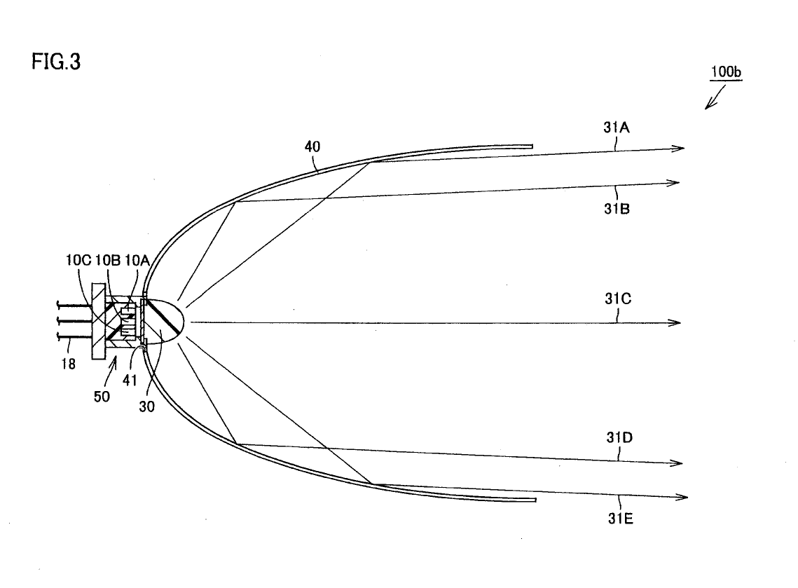

A light source device 100b according to a third embodiment of the invention will be described with reference to FIG. 3. In the third embodiment, only a point different from light source device 100a of the second embodiment will be described. Similarly to light source device 100 of the first embodiment, light source device 100b further includes reflecting mirror 40 having the substantially concave shape.

Reflecting mirror 40 may have the focal point. Light-scattering body 30 may be disposed so as to include the focal point of reflecting mirror 40. Light-scattering body 30 is irradiated with the laser beams oscillated from semiconductor laser elements 10A, 10B, and 10C through an opening 41 provided in reflecting mirror 40.

(Action and Effect)

The action and effect of light source device 100b of the third embodiment will be described below. Light source device 100b emits scattering light beams 31A to 31E while light-scattering body 30 does not convert the wavelengths of the laser beams. In order to obtain the desired luminance, light source device 100b can be produced so as to emit the laser beam having the energy smaller than that of the light emitting device including the fluorescent material.

In light source device 100b, the laser beams oscillated from semiconductor laser elements 10A, 10B, and 10C repeat the multiple scattering in light-scattering body 30 to form scattering light beams 31A to 31E, and scattering light beams 31A to 31E are scattered. Light-scattering body 30 constitutes a light source that emits scattering light beams 31A to 31E. The repetition of the multiple scattering decreases the coherency of each laser beam. Light source device 100b can suppress the generation of the stripe pattern caused by the overlapping (light interference) of the laser beam. Light source device 100b can suppress the harmful influence of the laser beam on the human body (eyes), and the high safeness is secured.

Light source device 100b can emit scattering light beams 31A to 31E having the desired directivity or luminance by designing reflecting mirror 40 into the desired dimensions or shape. Light source device 100b can emit scattering light beams 31A to 31E having the desired directivity or luminance and high floodlight efficiency by the design of reflecting mirror 40. Light source device 100b can be used as the light source that emits the light beams having the desired directivity or luminance by emitted scattering light beams 31A to 31E. Light source device 100b may be configured such that the combined light beam similar to that of the first embodiment is formed by scattering light beams 31A to 31E.

### Fourth Embodiment

### Configuration

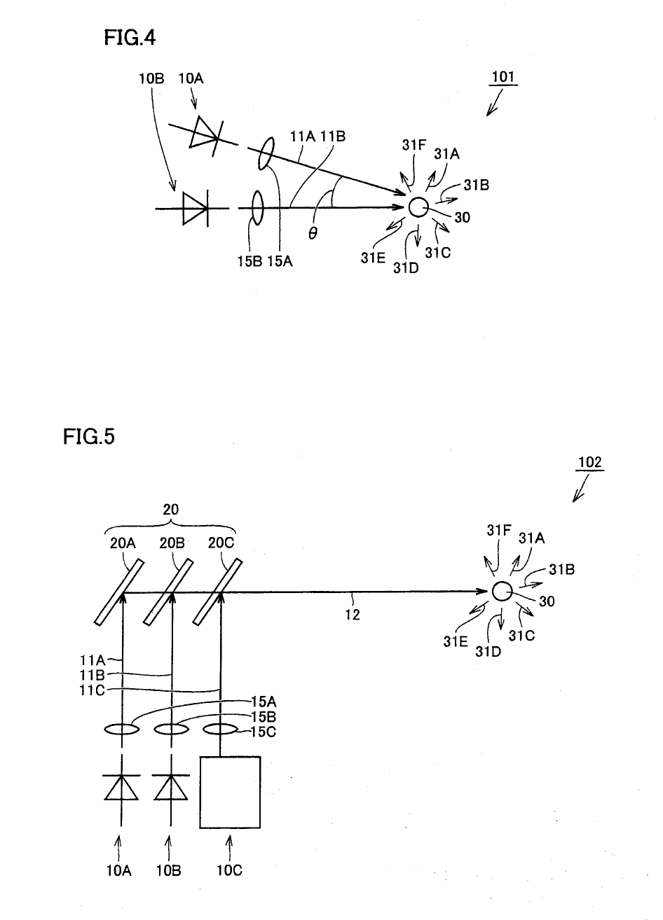

A light source device 101 according to a fourth embodiment of the invention will be described with reference to FIG. 4. Light source device 101 includes first semiconductor laser element 10A, second semiconductor laser element 10B, and light-scattering body 30.

(Semiconductor Laser Element)

First semiconductor laser element 10A oscillates first laser beam 11A having the visible-region wavelength. Second semiconductor laser element 10B oscillates second laser beam 11B having the visible-region wavelength. First semiconductor laser element 10A may oscillate first laser beam 11A having the blue wavelength, and second semiconductor laser element 10B may oscillate second laser beam 11B having the yellow wavelength that is different from that of first laser beam 11A. The color combination is not limited to the blue and the yellow. There is no particular limitation to the kind and configuration of the oscillated laser beam.

First semiconductor laser element 10A applies first laser beam 11A toward light-scattering body 30. Second semiconductor laser element 10B applies second laser beam 11B toward light-scattering body 30. Light-scattering body 30 is irradiated with first laser beam 11A and second laser beam 11B, which are independent of each other.

First laser beam 11A and second laser beam 11B may form parallel rays in order to accurately irradiate light-scattering body 30 with first laser beam 11A and second laser beam 11B. As used herein, the parallel rays is an academic term used in the field of optics and means a completely linear ray that does not spread even if the ray travels to an infinite distance.

The formation of the parallel rays by first laser beam 11A and second laser beam 11B means that first laser beam 11A and second laser beam 11B individually form the completely linear rays. In this case, the parallel rays do not mean that first laser beam 11A and second laser beam 11B are geometrically parallel to each other. Light-scattering body 30 may be irradiated with first laser beam 11A and second laser beam 11B while first laser beam 11A and second laser beam 11B are geometrically parallel to each other.

For example, light source device 101 may include a first collimator lens 15A in order that first laser beam 11A forms the parallel rays. First laser beam 11A is converted by passing through first collimator lens 15A, thereby forming the parallel rays. For example, light source device 101 may include a second collimator lens 15B in order that second laser beam 11B forms the parallel rays. Second laser beam 11B is converted by passing through second collimator lens 15B, thereby forming the parallel rays.

Light-scattering body 30 is irradiated with first laser beam 11A and second laser beam 11B that form the parallel rays. Light-scattering body 30 may directly be irradiated with first laser beam 11A oscillated from first semiconductor laser element 10A and second laser beam 11B oscillated from second semiconductor laser element 10B (without passing through collimator lens or light guide member described later). When a distance from first semiconductor laser element 10A and second laser beam 11B to light-scattering body 30 is sufficiently short, because light-scattering body 30 is sufficiently irradiated with first laser beam 11A and second laser beam 11B before first laser beam 11A and second laser beam 11B spread, occasionally it is not necessary to provide the collimator lens.

(Light-Scattering Body 30)

Light-scattering body 30 will be described based on first laser beam 11A. The same holds true for second laser beam 11B. Light-scattering body 30 scatters first laser beam 11A without changing the wavelength. “Without changing the wavelength” means that light-scattering body 30 scatters first laser beam 11A while the wavelength of first laser beam 11A is not changed at all, and “without changing the wavelength” does not include the case in which the wavelength of the laser beam is converted by the fluorescent material.

In order to prevent the heat generation of light-scattering body 30 due to oscillated first laser beam 11A, light source device 101 may further include the temperature controller that maintains light-scattering body 30 at a constant temperature. For example, the temperature controller is the cooling fan.

Light-scattering body 30 may include the base material made of the transparent resin or glass material and transparent light-scattering particles that are dispersed in the base material and has the refractive index different from that of the base material. For example, the resin is silicone. For example, the light-scattering particles are TiO₂ particles.

As to the dimensions of light-scattering body 30, light-scattering body 30 can be formed into the sphere having the diameter of about 1 mm to about 10 mm or the cube having the side of about 1 mm to about 10 mm. When light-scattering body 30 is irradiated with first laser beam 11A that forms the parallel rays with first collimator lens 15A, light-scattering body 30 forms an ideal point light source with decreasing dimensions of light-scattering body 30.

When light-scattering body 30 is irradiated with first laser beam 11A while first collimator lens 15A is not provided, the side of light-scattering body 30, which is irradiated with first laser beam 11A, may be formed into a planar shape having a predetermined area (see FIG. 1). When first collimator lens 15A is not provided, light-scattering body 30 is irradiated with first laser beam 11A while first laser beam 11A spreads with a predetermined width. Therefore, the case in which first collimator lens 15A is not provided is smaller than the case in which light-scattering body 30 is irradiated with first laser beam 11A while first laser beam 11A forms the parallel rays in the light density per unit area of first laser beam 11A with which light-scattering body 30 is irradiated.

When the distance from first semiconductor laser element 10A to light-scattering body 30 is sufficiently short, because light-scattering body 30 is sufficiently irradiated with first laser beam 11A before first laser beam 11A spreads, occasionally it is not necessary to provide first collimator lens 15A. When the need to provide first collimator lens 15A is eliminated, light-scattering body 30 on the side irradiated with first laser beam 11A can be formed into an arbitrary shape having a predetermined sectional area where light-scattering body 30 is sufficiently irradiated with first laser beam 11A.

Light-scattering body 30 on the side irradiated with first laser beam 11A is formed into the planar shape having the predetermined area, so that the light density of first laser beam 11A can be decreased and light-scattering body 30 can be prevented from generating the heat caused by first laser beam 11A. Light-scattering body 30 that is prevented from generating the heat can scatter first laser beam 11A, with which light-scattering body 30 is sufficiently irradiated, without losing the energy of first laser beam 11A.

(Laser Beam)

When scattered by light-scattering body 30, first laser beam 11A and second laser beam 11B may be mixed to form the laser beam having the color with which the irradiation object can visibly be recognized. For example, in order to form the white laser beam, light source device 101 may include the semiconductor laser element that oscillates the blue laser beam and the semiconductor laser element that oscillates the yellow laser beam. In order to form the white laser beam, light source device 101 may include the semiconductor laser element that oscillates the red laser beam and the semiconductor laser element that oscillates the blue-green laser beam.

(Action and Effect)

The action and effect of light source device 101 of the fourth embodiment will be described below with reference to FIG. 4. Light source device 101 includes first semiconductor laser element 10A and second semiconductor laser element 10B. First semiconductor laser element 10A and second semiconductor laser element 10B individually oscillate the laser beams having arbitrary colors, and the oscillated laser beams are mixed by light-scattering body 30. Light source device 101 can be used as the light source that emits the light having arbitrary color. Because light-scattering body 30 forms the ideal point light source with decreasing dimensions of light-scattering body 30, light-scattering body 30 is significantly useful.

First laser beam 11A and second laser beam 11B, with which light-scattering body 30 is irradiated, repeat the multiple scattering in light-scattering body 30. First laser beam 11A and second laser beam 11B, which repeat the multiple scattering, are combined in light-scattering body 30 and scattered as scattering light beams 31A to 31F that travel radially in arbitrary directions from the surface of light-scattering body 30. Light-scattering body 30 forms a light source that emits scattering light beams 31A to 31F. Light source device 101 that emits scattering light beams 31A to 31F can be used in various applications. Specifically, the various applications include not only the light source for lighting but also the light source for image projection as the substitution for the overhead projector lamp.

First laser beam 11A and second laser beam 11B have the high coherency before the repetition of the multiple scattering. After the repetition of the multiple scattering, light-scattering body 30 emits scattering light beam 31A to 31F each of which the coherency is sufficiently decreased. Because of the decreased coherency in first laser beam 11A and second laser beam 11B, light source device 101 can suppress the generation of the stripe pattern caused by the overlapping (light interference) of the laser beam. The coherency is decreased in first laser beam 11A and second laser beam 11B, and the apparent dimensions of the light source are enlarged to the dimensions of light-scattering body 30, so that light source device 101 can suppress the harmful influence of the laser beam on the human body (eyes).

Light source device 101 emits scattering light beams 31A to 31F while light-scattering body 30 does not convert the wavelengths of first laser beam 11A and second laser beam 11B. Even if scattering light beams 31A to 31F are emitted, the energy is not lost in first laser beam 11A and second laser beam 11B. Light source device 101 can emit scattering light beams 31A to 31F without generating the energy losses of first laser beam 11A and second laser beam 11B, which are oscillated from first semiconductor laser element 10A and second semiconductor laser element 10B. In order to obtain desired luminance, light source device 101 can be produced so as to emit the laser beam having the energy smaller than that of the light emitting device including the fluorescent material.

Although the two semiconductor laser elements are used in the fourth embodiment, at least two semiconductor laser elements that oscillate laser beams having different colors can also be configured.

### Fifth Embodiment

### Configuration

A light source device 102 according to a fifth embodiment of the invention will be described with reference to FIG. 5. Light source device 102 includes a combining member 20. More specifically light source device 102 includes first semiconductor laser element 10A, second semiconductor laser element 10B, third semiconductor laser element 10C, light-scattering body 30, and combining member 20. Similarly to light source device 101 of the fourth embodiment, light source device 102 may include first collimator lens 15A, second collimator lens 15B, and a third collimator lens 15C.

Combining member 20 includes a first mirror 20A, a second mirror 20B, and a third mirror 20C. Combining member 20 combines first laser beam 11A oscillated from first semiconductor laser element 10A, second laser beam 11B oscillated from second semiconductor laser element 10B, and third laser beam 11C oscillated from third semiconductor laser element 10C.

In light source device 101 of the fourth embodiment (see FIG. 4), light-scattering body 30 is irradiated with first laser beam 11A oscillated from first semiconductor laser element 10A and second laser beam 11B oscillated from second semiconductor laser element 10B, which are independent of each other.

On the other hand, in light source device 102 of the fifth embodiment (see FIG. 5), light-scattering body 30 is irradiated with first laser beam 11A oscillated from first semiconductor laser element 10A, second laser beam 11B oscillated from second semiconductor laser element 10B, and third laser beam 11C oscillated from third semiconductor laser element 10C while first laser beam 11A, second laser beam 11B, and third laser beam 11C are combined as one laser beam 12 by combining member 20.

First laser beam 11A, second laser beam 11B, and third laser beam 11C are combined by combining member 20 to form laser beam 12, which will be described in detail. First laser beam 11A oscillated from first semiconductor laser element 10A is reflected by first mirror 20A to irradiate light-scattering body 30 therewith. Second laser beam 11B oscillated from second semiconductor laser element 10B is reflected by second mirror 20B to irradiate light-scattering body 30 therewith. Second mirror 20B is a dielectric multilayer mirror. Second mirror 20B reflects 99% or more of only second laser beam 11B and transmits a light beam having another wavelength. First laser beam 11A that is reflected by first mirror 20A to irradiate light-scattering body 30 therewith is transmitted through second mirror 20B (from the left to the right in FIG. 5). First laser beam 11A transmitted through second mirror 20B is combined with second laser beam 11B.

Third laser beam 11C oscillated from third semiconductor laser element 10C is reflected by third mirror 20C to irradiate light-scattering body 30 therewith. Third mirror 20C is also a dielectric multilayer mirror similarly to second mirror 20B. Third mirror 20C reflects 99% or more of only third laser beam 11C and transmits a light beam having another wavelength. First laser beam 11A transmitted through second mirror 20B and second laser beam 11B that is reflected by second mirror 20B to irradiate light-scattering body 30 therewith are transmitted through third mirror 20C (from the left to the right in FIG. 5). First laser beam 11A and second laser beam 11B, which are transmitted through third mirror 20C, are combined with third laser beam 11C.

First laser beam 11A and second laser beam 11B, which are transmitted through third mirror 20C, are combined with third laser beam 11C to form one laser beam 12. Light-scattering body 30 is irradiated with laser beam 12 by combining member 20. Because other configurations (configurations of first semiconductor laser element 10A, second semiconductor laser element 10B, third semiconductor laser element 10C, and light-scattering body 30) are similar to those of light source device 101 of the fourth embodiment, the description is not repeated.

(Laser Beam)

When scattered by light-scattering body 30, first laser beam 11A, second laser beam 11B, and third laser beam 11C may be mixed to form the laser beam having the color with which the irradiation object can visibly be recognized. The color with which the irradiation object can visibly be recognized may be the white. In order to mix the scattered laser beams to form the color with which the irradiation object can visibly be recognized, in light source device 102, the semiconductor laser element that oscillates the blue laser beam is used as first semiconductor laser element 10A, the semiconductor laser element that oscillates the red laser beam is used as second semiconductor laser element 10B, and semiconductor laser element that oscillates the green laser beam is used as third semiconductor laser element 10C. Accordingly, first laser beam 11A has the blue laser beam, second laser beam 11B has the red laser beam, and the third laser beam 11C has the green laser beam.

For example, the semiconductor laser element that oscillates the red laser beam can be obtained by forming the AlGaInP material on the GaAs substrate. The semiconductor laser element that oscillates the red laser beam oscillates the laser beam having the wavelength of about 635 nm. For example, the semiconductor laser element that oscillates the blue laser beam can be obtained by forming the AlGaInN material on the GaN substrate or sapphire substrate. The semiconductor laser element that oscillates the blue laser beam oscillates the laser beam having the wavelength of about 445 nm.

For example, the semiconductor laser element that oscillates the green laser beam can be obtained by causing an infrared laser beam having a wavelength of about 808 nm and an infrared ray having wavelength of about 1064 nm oscillated from a Nd:YVO₄ crystal to pass through a nonlinear optical crystal. The semiconductor laser element that oscillates the green laser beam oscillates a second harmonic having a wavelength of about 532 nm. Although an AlGaInN material that directly oscillates the green laser beam is currently in the research and development stage and not commercially available, the AlGaInN material may be used as the semiconductor laser element that oscillates the green laser beam.

The semiconductor laser element that oscillates the red laser beam is oscillated with about 0.6 W, the semiconductor laser element that oscillates the blue laser beam is oscillated with about 1.5 W, and the semiconductor laser element that oscillates the green laser beam is oscillated with about 0.3 W, which allows the white light to be obtained. There is no particular limitation to the kind or configuration of the oscillated laser beam. Light source device 102 may include at least two semiconductor laser elements that oscillate laser beams having arbitrary colors according to the desired color used as the light source.

(Action and Effect)

According to light source device 102 of the fifth embodiment, even if first laser beam 11A, second laser beam 11B, and third laser beam 11C are combined by combining member 20 to form laser beam 12, the energy losses of first laser beam 11A, second laser beam 11B, and third laser beam 11C are not generated. Even if the energy losses of first laser beam 11A, second laser beam 11B, and third laser beam 11C are generated by combining member 20, the amount of energy loss is extremely low compared with the amount of energy loss in which the light emitting device including the fluorescent material converts the wavelength.

Because the energy losses of first laser beam 11A, second laser beam 11B, and third laser beam 11C are not generated by combining member 20, similarly to the fourth embodiment, the energy is not lost in first laser beam 11A, second laser beam 11B, and third laser beam 11C even if light-scattering body 30 is irradiated with laser beam 12 to emit scattering light beams 31A to 31F. Light source device 102 can emit scattering light beams 31A to 31F without generating the energy losses of first laser beam 11A oscillated from first semiconductor laser element 10A, second laser beam 11B oscillated from second semiconductor laser element 10B, and third laser beam 11C oscillated from third semiconductor laser element 10C. Because light-scattering body 30 forms the ideal point light source with decreasing dimensions of light-scattering body 30, light-scattering body 30 is significantly useful.

In light source device 101 of the fourth embodiment, because light-scattering body 30 is irradiated with first laser beam 11A and second laser beam 11B which are independent of each other, light-scattering body 30 is irradiated with first laser beam 11A and second laser beam 11B with a predetermined angle θ between first laser beam 11A and second laser beam 11B (see FIG. 4). It is necessary that light source device 101 has a space around light-scattering body 30 in order to irradiate light-scattering body 30 with first laser beam 11A and second laser beam 11B with the predetermined angle θ between first laser beam 11A and second laser beam 11B.

Referring to FIG. 5, according to light source device 102, first laser beam 11A, second laser beam 11B, and third laser beam 11C are combined by combining member 20 to form one laser beam 12, and light-scattering body 30 is irradiated with one laser beam 12. Light source device 102 may have the space around light-scattering body 30 in order to irradiate light-scattering body 30 with one laser beam 12. In light source device 102, the space around light-scattering body 30, which is necessary to irradiate light-scattering body 30 with the laser beam, can be reduced compared with light source device 101. In light source device 102, compared with light source device 101, various devices can be disposed by utilizing the space around light-scattering body 30.

Referring to FIG. 5, according to light source device 102, combining member 20 irradiates light-scattering body 30 with laser beam 12. Because light-scattering body 30 is properly irradiated with first laser beam 11A, second laser beam 11B, and third laser beam 11C, it is only necessary to accurately adjust an installation angle of combining member 20, and it is not necessary to adjust the installation angle of individual semiconductor laser element. The installation angle of combining member 20 such as a mirror is easily adjusted compared with the adjustment of the installation angle of individual semiconductor laser element, and a possibility of breakage is low. Light source device 102 can easily be installed with the low possibility of breakage compared with light source device 101.

### Sixth Embodiment

### Configuration

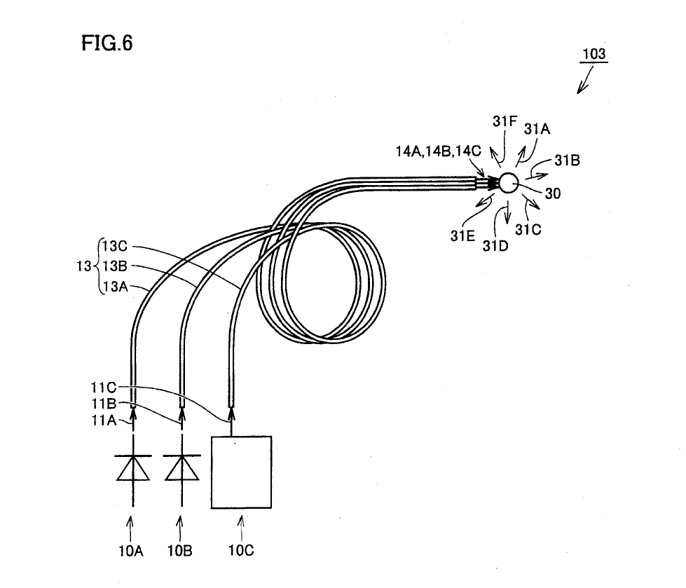

A light source device 103 according to a sixth embodiment of the invention will be described with reference to FIG. 6. Light source device 103 includes a light guiding unit 13. More specifically, light source device 103 includes first semiconductor laser element 10A, second semiconductor laser element 10B, third semiconductor laser element 10C, light-scattering body 30, and light guiding unit 13.

Light guiding unit 13 includes a first optical fiber 13A, a second optical fiber 13B, and a third optical fiber 13C. First optical fiber 13A guides first laser beam 11A oscillated from first semiconductor laser element 10A to light-scattering body 30, and light-scattering body 30 is irradiated with a first laser beam 14A that is first laser beam 11A. Second optical fiber 13B guides second laser beam 11B oscillated from second semiconductor laser element 10B to light-scattering body 30, and light-scattering body 30 is irradiated with a second laser beam 14B that is second laser beam 11B. Third optical fiber 13C guides third laser beam 11C oscillated from third semiconductor laser element 10C to light-scattering body 30, and light-scattering body 30 is irradiated with a third laser beam 14C that is third laser beam 11C.

In the sixth embodiment, the optical fiber is used as light guiding unit 13. Light guiding unit 13 is not limited to the optical fiber. For example, a light guide made of quartz may be used as light guiding unit 13. Because other configurations (configurations of first semiconductor laser element 10A, second semiconductor laser element 10B, third semiconductor laser element 10C, and light-scattering body 30) are similar to those of light source device 102 of the fifth embodiment, the description is not repeated.

(Action and Effect)

According to light source device 103 of the sixth embodiment, light guiding unit 13 irradiates light-scattering body 30 with first laser beam 14A, second laser beam 14B, and third laser beam 14C, which are independent of one another. According to light source device 103, the energy losses of first laser beam 11A, second laser beam 11B, and third laser beam 11C are not generated even if first laser beam 11A, second laser beam 11B, and third laser beam 11C are guided by light guiding unit 13 to become first laser beam 14A, second laser beam 14B, and third laser beam 14C. Even if the energy losses of first laser beam 11A, second laser beam 11B, and third laser beam 11C are generated by light guiding unit 13, the amount of energy loss is extremely low compared with the amount of energy loss in which the light emitting device including the fluorescent material converts the wavelength.

Because the energy losses of first laser beam 11A, second laser beam 11B, and third laser beam 11C are not generated by light guiding unit 13, similarly to the fifth embodiment, the energy is not lost in first laser beam 11A, second laser beam 11B, and third laser beam 11C even if light-scattering body 30 is irradiated with first laser beam 11A, second laser beam 11B, and third laser beam 11C as first laser beam 14A, second laser beam 14B, and third laser beam 14C to emit scattering light beams 31A to 31F. Light source device 103 can emit scattering light beams 31A to 31F without generating the energy losses of first laser beam 11A oscillated from first semiconductor laser element 10A, second laser beam 11B oscillated from second semiconductor laser element 10B, and third laser beam 11C oscillated from third semiconductor laser element 10C. Because light-scattering body 30 forms the ideal point light source with decreasing dimensions of light-scattering body 30, light-scattering body 30 is significantly useful.

In light source device 101 of the fourth embodiment, light-scattering body 30 is irradiated with first laser beam 11A and second laser beam 11B through the predetermined space between light-scattering body 30 and each of first semiconductor laser element 10A and second semiconductor laser element 10B (see FIG. 4). In light source device 101, it is necessary that light source device 101 has the space that is paths for first laser beam 11A and second laser beam 11B between light-scattering body 30 and each of first semiconductor laser element 10A and second semiconductor laser element 10B when various devices are disposed between light-scattering body 30 and each of first semiconductor laser element 10A and second semiconductor laser element 10B.

In light source device 102 of the fifth embodiment, light-scattering body 30 is irradiated with first laser beam 11A, second laser beam 11B, and third laser beam 11C, which are oscillated from semiconductor laser elements 10A, 10B, and 10C, through the predetermined space between combining member 20 and each of semiconductor laser elements 10A, 10B, and 10C and the predetermined space between combining member 20 and light-scattering body 30 (see FIG. 5). In light source device 102, it is necessary that light source device 102 has the space that is paths for laser beams 11A, 11B, and 11C between light-scattering body 30 and each of semiconductor laser elements 10A, 10B, and 10C when various devices are disposed between combining member 20 and each of semiconductor laser elements 10A, 10B, and 10C or between light-scattering body 30 and each of semiconductor laser elements 10A, 10B, and 10C.

Referring to FIG. 6, according to light source device 103 of the sixth embodiment, laser beams 11A, 11B, and 11C oscillated from semiconductor laser elements 10A, 10B, and 10C are guided by light guiding unit 13, and light-scattering body 30 is irradiated with laser beams 14A, 14B, and 14C. Light source device 103 may have the space around light-scattering body 30 in order to irradiate light-scattering body 30 with laser beams 14A, 14B, and 14C.

In light source device 103, even if various devices are disposed between light-scattering body 30 and each of semiconductor laser elements 10A, 10B, and 10C, laser beams 11A, 11B, and 11C can be guided by light guiding unit 13 so as to avoid various devices. In light source device 103, light-scattering body 30 can be irradiated with laser beams 14A, 14B, and 14C by light guiding unit 13. In light source device 103, compared with light source device 101 and light source device 102, various devices can be disposed between light-scattering body 30 and each of semiconductor laser elements 10A, 10B, and 10C.

### Seventh Embodiment

### Configuration

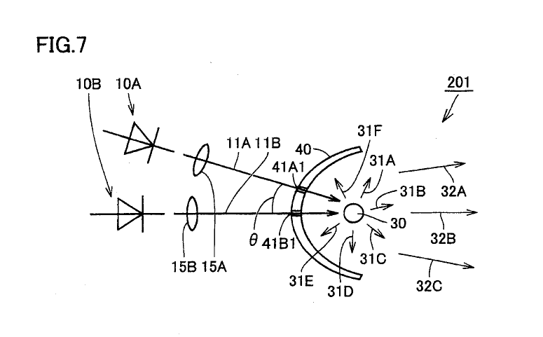

A light source device 201 according to a seventh embodiment of the invention will be described with reference to FIG. 7. Light source device 201 further includes reflecting mirror 40 having the substantially concave shape in addition to the configuration of light source device 101 of the fourth embodiment. More specifically, light source device 201 includes first semiconductor laser element 10A, second semiconductor laser element 10B, light-scattering body 30, and reflecting mirror 40.

Reflecting mirror 40 may have the focal point. Light-scattering body 30 may be disposed so as to include the focal point of reflecting mirror 40. The floodlight efficiency of reflecting mirror 40 is enhanced when light-scattering body 30 is disposed so as to include the focal point of reflecting mirror 40. Similarly to light source device 101 of the fourth embodiment, light source device 201 may include first collimator lens 15A and second collimator lens 15B.

Even in the configuration of the seventh embodiment, when the distance from first semiconductor laser element 10A and second semiconductor laser element 10B to light-scattering body 30 is sufficiently short, occasionally it is not necessary to provide the collimator lens.

First semiconductor laser element 10A applies first laser beam 11A toward light-scattering body 30. Second semiconductor laser element 10B applies second laser beam 11B toward light-scattering body 30. In FIG. 7, light-scattering body 30 is irradiated with first laser beam 11A and second laser beam 11B through reflecting mirror 40.

When light-scattering body 30 is irradiated with first laser beam 11A and second laser beam 11B through reflecting mirror 40, a first opening (pinhole) 41A1 and a second opening 41B1 may be provided at positions corresponding to the paths for first laser beam 11A and second laser beam 11B in reflecting mirror 40, respectively.

Light-scattering body 30 may be irradiated with first laser beam 11A and second laser beam 11B from the side (the right of reflecting mirror 40 in FIG. 7), on which the outgoing port of reflecting mirror 40 exists, without passing through reflecting mirror

(Action and Effect)

Similarly to the fourth embodiment, first laser beam 11A and second laser beam 11B, which are applied toward light-scattering body 30, repeat the multiple scattering in light-scattering body 30. First laser beam 11A and second laser beam 11B, which repeat the multiple scattering, are combined in light-scattering body 30 to form scattering light beams 31A to 31F, and scattering light beams 31A to 31F are radially scattered in arbitrary directions from the surface of light-scattering body 30. Light-scattering body 30 forms a light source that emits scattering light beams 31A to 31F.

In scattering light beams 31A to 31F, scattering light beams 31A to 31C are emitted toward the opposite direction to reflecting mirror 40 (from the left to the right in FIG. 7). In scattering light beams 31A to 31F, scattering light beam 31D to 31F that are emitted toward reflecting mirror 40 (from the right to the left in FIG. 7) are reflected by reflecting mirror 40. Scattering light beams 31A to 31C and reflected scattering light beams 31D and 31F are further combined to form combined light beams 32A to 32C having the directivity, and combined light beams 32A to 32C are emitted. Light-scattering body 30 forms the ideal point light source with decreasing dimensions of light-scattering body 30. Light-scattering body 30 is disposed as the extremely small point light source so as to include the focal point of reflecting mirror 40, which allows reflecting mirror 40 to efficiently control the light flux.

Light source device 201 can emit combined light beams 32A to 32C having the desired directivity or luminance by designing reflecting mirror 40 into the desired dimensions or shape. Light source device 201 can emit combined light beams 32A to 32C having the desired directivity or luminance and high floodlight efficiency by the design of reflecting mirror 40. Light source device 201 can be used as the light source that emits the light beams having the desired directivity or luminance by emitted combined light beams 32A to 32C. Reflecting mirror 40 is formed into the parabolic shape (parabolic mirror), and the smallest point light source is disposed at the focal position of reflecting mirror 40, which allows the parallel-ray-shaped floodlight of the visible combined light beam each of which the coherency is sufficient decreased. At this point, an optical system suitable to applications such as a floodlighting device and a spot light can easily be designed as light source device 201. The floodlight can be performed by forming reflecting mirror 40 into the parabolic shape (parabolic mirror), and the light can be collected by forming reflecting mirror 40 into an ellipsoidal mirror.

According to light source device 201, the energy losses of first laser beam 11A and second laser beam 11B are not generated even if scattering light beams 31D to 31F are reflected by reflecting mirror 40. Even if the energy losses of first laser beam 11A and second laser beam 11B are generated by reflecting mirror 40, the amount of energy loss is extremely low compared with the amount of energy loss in which the light emitting device including the fluorescent material converts the wavelength.

Because the energy losses of scattering light beams 31D to 31F are not generated by reflecting mirror 40, similarly to the fourth embodiment, the energy is not lost in first laser beam 11A and second laser beam 11B even if light-scattering body 30 is irradiated with first laser beam 11A and second laser beam 11B to emit combined light beams 32A to 32C. Light source device 201 can emit combined light beams 32A to 32C without generating the energy losses of first laser beam 11A oscillated from first semiconductor laser element 10A and second laser beam 11B oscillated from second semiconductor laser element 10B.

### Eighth Embodiment

### Configuration

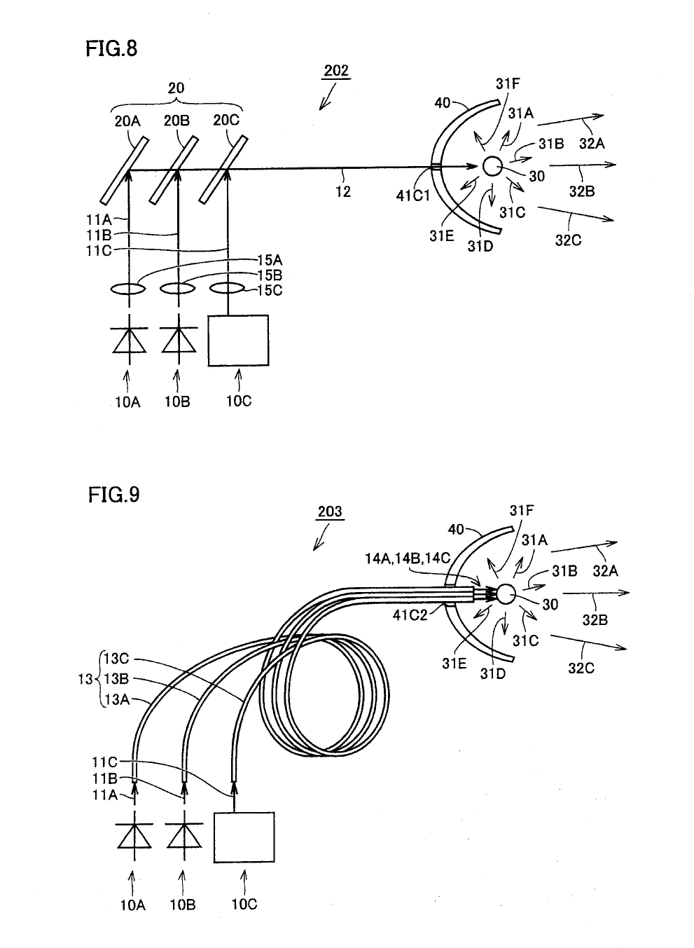

A light source device 202 according to an eighth embodiment of the invention will be described with reference to FIG. 8. Light source device 202 further includes reflecting mirror 40 having the substantially concave shape in addition to the configuration of light source device 102 of the fifth embodiment including combining member 20.

More specifically, light source device 202 includes first semiconductor laser element 10A, second semiconductor laser element 10B, third semiconductor laser element 10C, combining member 20, light-scattering body 30, and reflecting mirror 40. Similarly to light source device 201 of the seventh embodiment, light source device 202 may include first collimator lens 15A, second collimator lens 15B, and third collimator lens 15C.

Combining member 20 is identical to combining member 20 of the fifth embodiment. First laser beam 11A oscillated from first semiconductor laser element 10A, second laser beam 11B oscillated from second semiconductor laser element 10B, and third laser beam 11C oscillated from third semiconductor laser element 10C are combined by combining member 20 to form one laser beam 12.

Light-scattering body 30 is irradiated with laser beam 12 by combining member 20. In FIG. 8, light-scattering body 30 is irradiated with laser beam 12 through reflecting mirror 40. Light-scattering body 30 may be irradiated with laser beam 12 from the side (the right of reflecting mirror 40 in FIG. 8), on which the outgoing port of reflecting mirror 40 exists, without passing through reflecting mirror 40.

Similarly to the seventh embodiment, when light-scattering body 30 is irradiated with first laser beam 11A, second laser beam 11B, and third laser beam 11C through reflecting mirror 40, an opening (pinhole) 41C1 may be provided at a position corresponding to the path of each of laser beams 11A, 11B, and 11C (laser beam 12) in reflecting mirror 40. Because other configurations (configurations of first semiconductor laser element 10A, second semiconductor laser element 10B, third semiconductor laser element 10C, light-scattering body 30, and reflecting mirror 40) are similar to those of light source device 102 of the fifth embodiment and light source device 201 of the seventh embodiment, the description is not repeated.

(Action and Effect)

Similarly to the fifth embodiment, according to light source device 202, the energy losses of first laser beam 11A, second laser beam 11B, and third laser beam 11C are not generated even if first laser beam 11A, second laser beam 11B, and third laser beam 11C are combined by combining member 20 to form laser beam 12. Light source device 202 can emit combined light beams 32A to 32C without generating the energy losses of first laser beam 11A oscillated from first semiconductor laser element 10A, second laser beam 11B oscillated from second semiconductor laser element 10B, and third laser beam 11C oscillated from third semiconductor laser element 10C.

Similarly to the configuration of the fifth embodiment, according to light source device 202, first laser beam 11A, second laser beam 11B, and third laser beam 11C are combined by combining member 20 to form one laser beam 12, and light-scattering body 30 is irradiated with one laser beam 12. In light source device 202, compared with light source device 201, various devices can be disposed by utilizing the space around light-scattering body 30.

Similarly to the seventh embodiment, reflecting mirror 40 is formed into the parabolic shape (parabolic mirror), and the smallest point light source is disposed at the focal position of reflecting mirror 40, which allows the parallel-ray-shaped floodlight of the visible combined light beam each of which the coherency is sufficiently decreased. At this point, according to light source device 202, the optical system suitable to applications such as the floodlighting device and the spot light can easily be designed.

### Ninth Embodiment

### Configuration

A light source device 203 according to a ninth embodiment of the invention will be described with reference to FIG. 9. Light source device 203 further includes reflecting mirror 40 having the substantially concave shape in addition to the configuration of light source device 103 of the sixth embodiment including light guiding unit 13. More specifically, light source device 203 includes first semiconductor laser element 10A, second semiconductor laser element 10B, third semiconductor laser element 10C, light-scattering body 30, light guiding unit 13, and reflecting mirror 40.

Light guiding unit 13 includes first optical fiber 13A, second optical fiber 13B, and third optical fiber 13C. Light guiding unit 13 guides laser beams 11A, 11B, and 11C oscillated from semiconductor laser elements 10A, 10B, and 10C to light-scattering body 30. Light guiding unit 13 irradiates light-scattering body 30 with guided laser beams 11A, 11B, and 11C as laser beams 14A, 14B, and 14C.

In FIG. 9, light-scattering body 30 is irradiated with laser beams 14A, 14B, and 14C through an opening 41C2 provided in reflecting mirror 40. When light-scattering body 30 is irradiated with laser beams 14A, 14B, and 14C through an opening 41C2 provided in reflecting mirror 40, light guiding unit 13 guides laser beams 11A, 11B, and 11C to the neighborhood of light-scattering body 30, and light-scattering body 30 is irradiated with guided laser beams 11A, 11B, and 11C as laser beams 14A, 14B, and 14C from the neighborhood of light-scattering body 30.

Because other configurations (configurations of first semiconductor laser element 10A, second semiconductor laser element 10B, third semiconductor laser element 10C, light-scattering body 30, and reflecting mirror 40) are similar to those of light source device 103 of the sixth embodiment and light source device 201 of the seventh embodiment, the description is not repeated.

(Action and Effect)

According to light source device 203 of the ninth embodiment, similarly to the configuration of the sixth embodiment, light guiding unit 13 irradiates light-scattering body 30 with laser beams 14A, 14B, and 14C, which are independent of one another. According to light source device 203, the energy losses of laser beams 11A, 11B, and 11C are not generated even if laser beams 11A, 11B, and 11C are guided by light guiding unit 13 to become laser beams 14A, 14B, and 14C.

Because the energy losses of laser beams 11A, 11B, and 11C are not generated by light guiding unit 13, similarly to the configuration of the sixth embodiment, the energy is not lost in laser beams 11A, 11B, and 11C even if light-scattering body 30 is irradiated with laser beams 11A, 11B, and 11C as laser beams 14A, 14B, and 14C to emit scattering light beams 31A to 31F. Light source device 203 can emit combined light beams 32A to 32C without generating the energy losses of laser beams 11A, 11B, and 11C oscillated from semiconductor laser elements 10A, 10B, and 10C.

Similarly to the seventh embodiment, reflecting mirror 40 is formed into the parabolic shape (parabolic mirror), and the smallest point light source is disposed at the focal position of reflecting mirror 40, which allows the parallel-ray-shaped floodlight of the visible combined light beam each of which the coherency is sufficiently decreased. At this point, according to light source device 203, the optical system suitable to applications such as the floodlighting device and the spot light can easily be designed.

### Tenth Embodiment

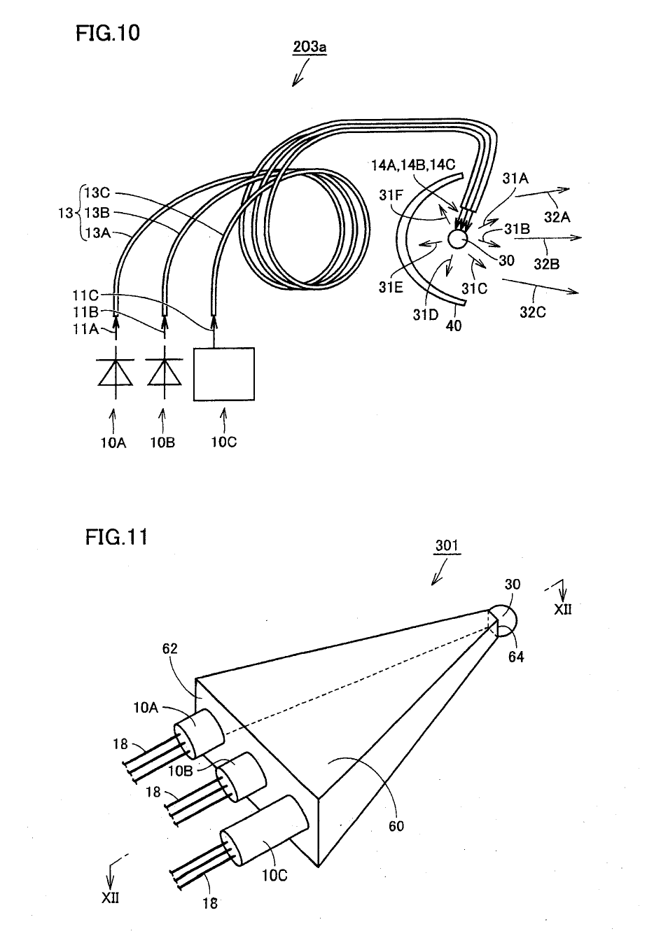

A light source device 203a according to a tenth embodiment of the invention will be described with reference to FIG. 10. In light source device 203a, compared with light source device 203 of the ninth embodiment, opening 41C2 is not provided in reflecting mirror 40, and light guiding unit 13 is provided such that light-scattering body 30 is irradiated with first laser beam 14A, second laser beam 14B, and third laser beam 14C from the side (the right of reflecting mirror 40 in FIG. 10) on which the outgoing port of reflecting mirror 40 exists. Other configurations are similar to those of light source device 203 of the ninth embodiment.

In the configuration of the tenth embodiment, similarly to light source device 203 of the ninth embodiment, light source device 203a can emit combined light beams 32A to 32C without generating the energy losses of laser beams 11A, 11B, and 11C oscillated from semiconductor laser elements 10A, 10B, and 10C.

Similarly to the seventh embodiment, reflecting mirror 40 is formed into the parabolic shape (parabolic mirror), and the smallest point light source is disposed at the focal position of reflecting mirror 40, which allows the parallel-ray-shaped floodlight of the visible combined light beam each of which the coherency is sufficiently decreased. At this point, according to light source device 203a, the optical system suitable to applications such as the floodlighting device and the spot light can easily be designed.

### Eleventh Embodiment

### Configuration

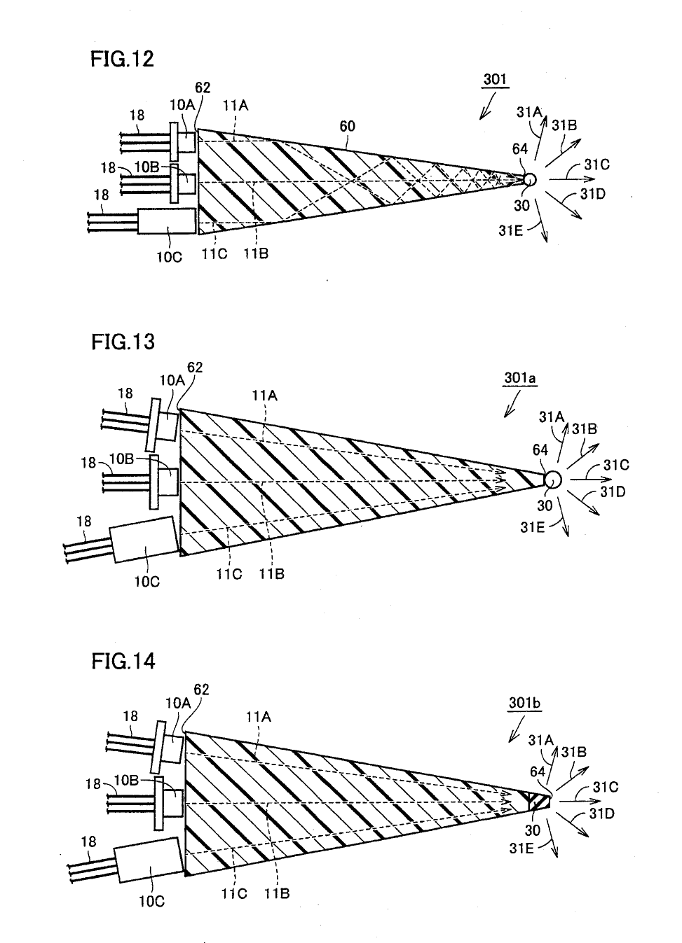

A light source device 301 according to an eleventh embodiment of the invention will be described with reference to FIGS. 11 and 12. Referring to FIG. 11, light source device 301 includes first semiconductor laser element 10A, second semiconductor laser element 10B, third semiconductor laser element 10C, light-scattering body 30, and light guide member 60 that is the light guiding unit.

Semiconductor laser elements 10A, 10B, and 10C oscillate the visible-region laser beams having different wavelengths. The laser beams oscillated from semiconductor laser elements 10A, 10B, and 10C having the wavelengths that are different from one another.

An outer shape of light guide member 60 is formed into a substantially truncated pyramid shape. As used herein, the truncated pyramid shape means a shape in which a vertex portion of a circular cone or a polygonal pyramid such as a square pyramid is cut by a surface whose area is smaller than that of a bottom surface. Light guide member 60 is made of a material that is transparent with respect to the visible light. For example, light guide member 60 is optical glass (BK7) or resin having the transparency with respect to the visible light. Light guide member 60 includes a light incident surface 62 (bottom surface) and a light outgoing surface 64 whose surface area is smaller than that of light incident surface 62.

Semiconductor laser elements 10A, 10B, and 10C are disposed close to the side of light incident surface 62 such that laser beams (11A, 11B, and 11C) oscillated from semiconductor laser elements 10A, 10B, and 10C are oriented toward the inside of light guide member 60. Light-scattering body 30 is disposed close to the side of light outgoing surface 64 so as to be irradiated with laser beams (11A, 11B, and 11C) guided in light guide member 60.

Referring to FIG. 12, first semiconductor laser element 10A may be disposed such that first laser beam 11A oscillated from first semiconductor laser element 10A is guided toward the side of light outgoing surface 64 from the side of light incident surface 62 while total internal reflection of first laser beam 11A is repeated in light guide member 60.

Third semiconductor laser element 10C may be disposed such that third laser beam 11C oscillated from third semiconductor laser element 10C is guided toward the side of light outgoing surface 64 from the side of light incident surface 62 while the total internal reflection of third laser beam 11C is repeated in light guide member 60.

In FIG. 12, optical axes of the laser beams are expressed by broken lines (11A to 11C). The broken lines (11A to 11C) schematically express optical axis directions of the laser beams and the state of the reflection in light guide member 60. Actually, each laser beam spreads with a predetermined radiation angle with respect to each of semiconductor laser elements 10A to 10C while centering around the optical axis, and the laser beams are emitted. Even if each laser beam is emitted while spreading, the total internal reflection of the laser beam including the spreading light beam is generated in light guide member 60, and the laser beams are collected to light outgoing surface 64. The same holds true for FIGS. 13 to 17.

A predetermined command is provided from the outside to each of semiconductor laser elements 10A, 10B, and 10C through lead wire 18, which allows semiconductor laser elements 10A, 10B, and 10C to independently oscillate the laser beams. When scattered by light-scattering body 30, laser beams 11A, 11B, and 11C oscillated from semiconductor laser elements 10A, 10B, and 10C may be mixed to form the laser beam having the color with which the irradiation object can visibly be recognized.

For example, in order to form the white laser beam, first semiconductor laser element 10A may oscillate the blue laser beam in light source device 301. Second semiconductor laser element 10B may oscillate the red laser beam. Third semiconductor laser element 10C may oscillate the green laser beam. There is no limitation to the color combination. There is also no particular limitation to the kind or configuration of the oscillated laser beam or the number of oscillated laser beams.

(Action and Effect)

The action and effect of light source device 301 of the eleventh embodiment will be described below. In light source device 301, semiconductor laser elements 10A, 10B, and 10C individually oscillate the laser beams 11A, 11B, and 11C having arbitrary colors. Laser beams 11A, 11B, and 11C are guided toward light outgoing surface 64 while (totally internally) reflected in light guide member 60. Laser beams 11A, 11B, and 11C reach light-scattering body 30 through light outgoing surface 64. A slope angle on a slope side of light guide member 60 may be designed such that laser beams 11A, 11B, and 11C are guided while totally internally reflected.

Laser beams 11A, 11B, and 11C repeat the multiple scattering in light-scattering body 30. After the repetition of the multiple scattering, the laser beams are combined in light-scattering body 30 to form scattering light beams 31A to 31E, and scattering light beams 31A to 31E are radially scattered in arbitrary directions from the surface of light-scattering body 30. Light-scattering body 30 forms a light source that emits scattering light beams 31A to 31E.

Light-scattering body 30 emits scattering light beam 31A to 31E each of which the coherency is sufficiently decreased by the repetition of the multiple scattering. Because of the decreased coherency of each laser beam, light source device 301 can suppress the generation of the stripe pattern by the overlapping (light interference) of the laser beams. The coherency is decreased in each laser beam, and the apparent dimensions of the light source are enlarged to the dimensions of light-scattering body 30, so that light source device 301 can suppress the harmful influence of the laser beam on the human body (eyes).

Because light source device 301 includes light guide member 60, the demand for attaching accuracy of semiconductor laser elements 10A, 10B, and 10C can be lowered unlike the light source devices (configuration in which the parallel rays are formed by causing the laser beam to pass through the collimate lens or configuration in which the optical fiber is used as the light guiding unit) of the first to ninth embodiments. In other words, each laser beam can be collected and scattered in alignment free. Even if a vibration is generated in light source device 301 by an external factor, the alignment is hardly jolted out of or the breakage is hardly generated.

### Twelfth Embodiment

A light source device 301a according to a twelfth embodiment of the invention will be described with reference to FIG. 13. In the twelfth embodiment, only a point different from light source device 301 of the eleventh embodiment will be described. In light source device 301a, semiconductor laser elements 10A, 10B, and 10C are disposed such that all the optical axes of laser beams 11A, 11B, and 11C oscillated from semiconductor laser elements 10A, 10B, and 10C are oriented toward light-scattering body 30.

Laser beams 11A, 11B, and 11C are guided in light guide member 60 while all the optical axes of laser beams 11A, 11B, and 11C are oriented toward light-scattering body 30. The laser beams are not reflected in light guide member 60 (or because the number of reflection times is extremely decreased), the energy losses of laser beams 11A, 11B, and 11C can be suppressed.

### Thirteenth Embodiment

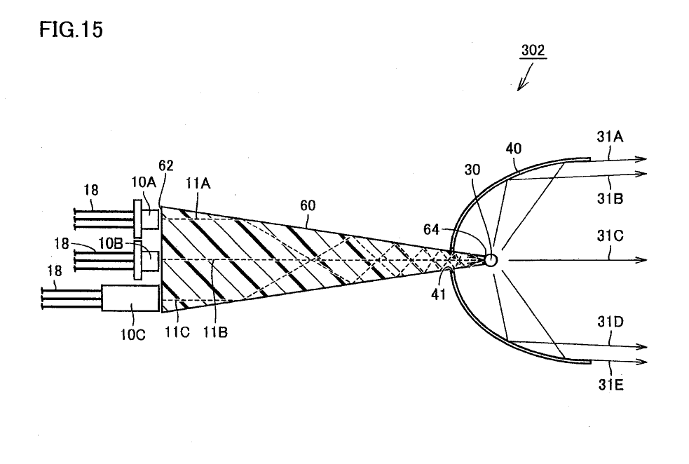

A light source device 301b according to a thirteenth embodiment of the invention will be described with reference to FIG. 14. In the thirteenth embodiment, only a point different from light source device 301a of the twelfth embodiment will be described. In light source device 301b, light-scattering body 30 is integral with (jointed to) light guide member 60 on the side of light outgoing surface 64. Light-scattering body 30 is assembled on the side of light outgoing surface 64 of light guide member 60, whereby light-scattering body 30 is integral with light guide member 60.

After laser beams 11A, 11B, and 11C are guided in light guide member 60, light-scattering body 30 is irradiated with laser beams 11A, 11B, and 11C (laser beams 11A, 11B, and 11C are incident to light-scattering body 30). The energy losses of laser beams 11A, 11B, and 11C can be suppressed between (the side of light outgoing surface 64 of) light guide member 60 and light-scattering body 30.

### Fourteenth Embodiment

A light source device 302 according to a fourteenth embodiment of the invention will be described with reference to FIG. 15. In the fourteenth embodiment, only a point different from light source device 301a of the twelfth embodiment will be described. Light source device 302 further includes reflecting mirror 40 having the substantially concave shape similarly to the first embodiment. Reflecting mirror 40 may have the focal point. Light-scattering body 30 may be disposed so as to include the focal point of reflecting mirror 40.

After laser beams 11A, 11B, and 11C oscillated from semiconductor laser elements 10A, 10B, and 10C are guided in light guide member 60, light-scattering body 30 is irradiated with laser beams 11A, 11B, and 11C. Light-scattering body 30 is irradiated with laser beams 11A, 11B, and 11C through opening 41 provided in reflecting mirror 40. Laser beams 11A, 11B, and 11C are combined in light-scattering body 30 to form scattering light beam 31A to 31E, and scattering light beam 31A to 31E are radially scattered in arbitrary directions from the surface of light-scattering body 30. Light source device 302 may be configured such that the combined light beam similar to that of the first embodiment is formed by scattering light beam 31A to 31E.

Light source device 302 can emit scattering light beam 31A to 31E having the desired directivity or luminance by designing reflecting mirror 40 into the desired dimensions or shape. Light source device 302 can emit scattering light beam 31A to 31E having the desired directivity or luminance and high floodlight efficiency by the design of reflecting mirror 40. Light source device 302 can be used as the light source that emits the light beams having the desired directivity or luminance by emitted combined light beams 31A to 31E.

### Fifteenth Embodiment

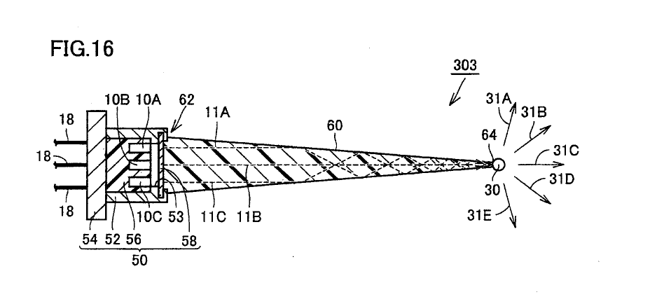

A light source device 303 according to a fifteenth embodiment of the invention will be described with reference to FIG. 16. Light source device 303 includes first semiconductor laser element 10A, second semiconductor laser element 10B, third semiconductor laser element 10C, light-scattering body 30, package 50, and light guide member 60.

Semiconductor laser elements 10A, 10B, and 10C and package 50 are configured similarly to light source device 100a (see FIG. 2) of the second embodiment. Light guide member 60 is configured similarly to light source device 301 (see FIG. 11) of the eleventh embodiment.

In light source device 303 of the fifteenth embodiment, light incident surface 62 of light guide member 60 may be disposed so as to come into close contact with glass 58 of package 50.

(Action and Effect)

In light source device 303, the dimensions of light-scattering body 30 can be reduced compared with the dimensions of light-scattering body 30 of light source device 100a (see FIG. 2) of the second embodiment. For example, light-scattering body 30 that is smaller than an interval between semiconductor laser elements 10A, 10B, and 10C can be used in light source device 303. Light-scattering body 30 can form the ideal point light source by the use of light-scattering body 30 having the smaller dimensions.

In light source device 303 of the fifteenth embodiment, similarly to the twelfth embodiment, semiconductor laser elements 10A, 10B, and 10C may be disposed such that all the optical axes of laser beams 11A, 11B, and 11C oscillated from semiconductor laser elements 10A, 10B, and 10C are oriented toward light-scattering body 30. In light source device 303 of the fifteenth embodiment, similarly to the thirteenth embodiment, light-scattering body 30 may be integral with light guide member 60.

### Sixteenth Embodiment

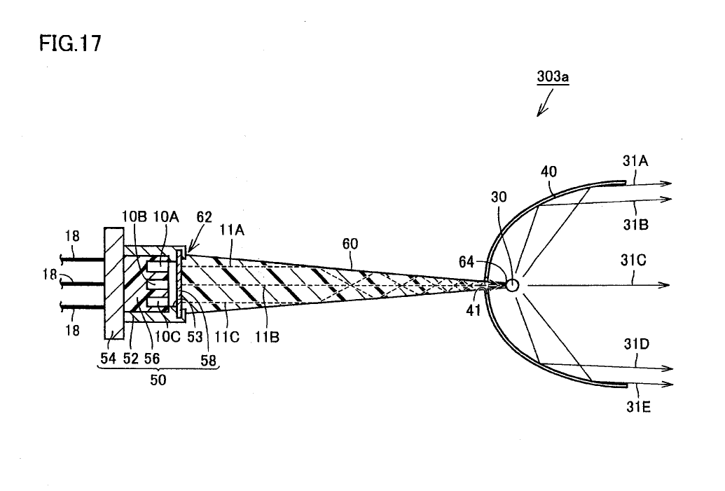

A light source device 303a according to a sixteenth embodiment of the invention will be described with reference to FIG. 17. In the sixteenth embodiment, only a point different from light source device 303 of the fifteenth embodiment will be described. Light source device 303a further includes reflecting mirror 40 having the substantially concave shape similarly to the first embodiment. Reflecting mirror 40 may have the focal point. Light-scattering body 30 may be disposed so as to include the focal point of reflecting mirror 40.

After laser beams 11A, 11B, and 11C oscillated from semiconductor laser elements 10A, 10B, and 10C are guided in light guide member 60, light-scattering body 30 is irradiated with laser beams 11A, 11B, and 11C. Light-scattering body 30 is irradiated with laser beams 11A, 11B, and 11C through opening 41 provided in reflecting mirror 40. Laser beams 11A, 11B, and 11C are combined in light-scattering body 30 to form scattering light beam 31A to 31E, and scattering light beam 31A to 31E are radially scattered in arbitrary directions from the surface of light-scattering body 30. Light source device 303a may be configured such that the combined light beam similar to that of the first embodiment is formed by scattering light beam 31A to 31E.

Light source device 303a can emit scattering light beam 31A to 31E having the desired directivity or luminance by designing reflecting mirror 40 into the desired dimensions or shape. Light source device 303a can emit combined light beams 32A to 32E having the desired directivity or luminance and high floodlight efficiency by the design of reflecting mirror 40. Light source device 303a can be used as the light source that emits the light beams having the desired directivity or luminance by emitted scattering light beams 31A to 31E.

In the first to sixteenth embodiments, the two semiconductor laser elements or the three semiconductor laser elements are used. There is no limitation to the number of semiconductor laser elements. In order to obtain the more suitable white light, laser beams having at least four kinds of the colors can be used by utilizing at least four semiconductor laser elements.

### Seventeenth Embodiment

### Configuration

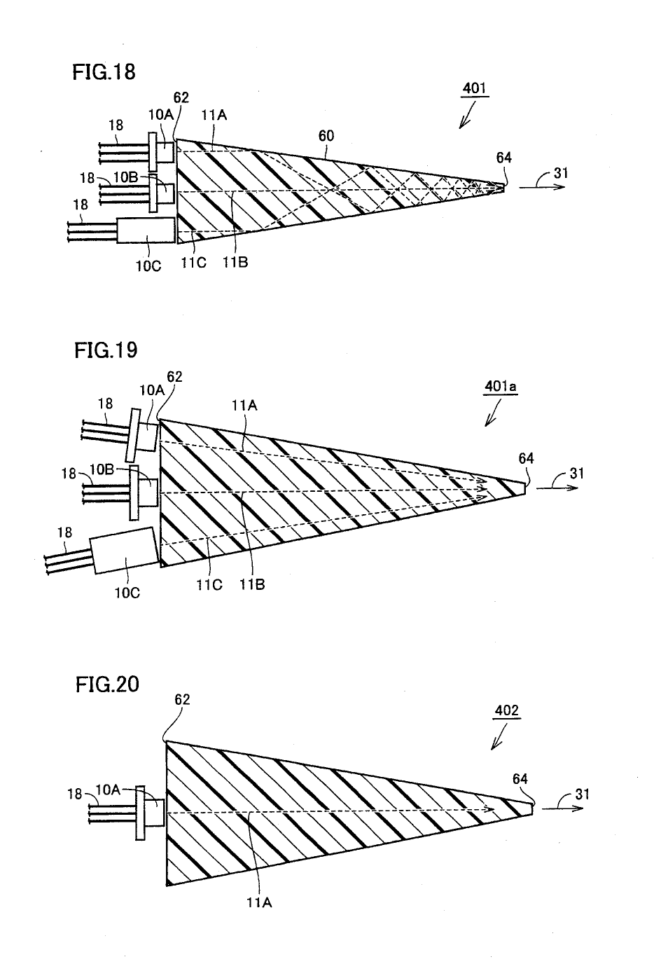

A light source device 401 according to a seventeenth embodiment of the invention will be described with reference to FIG. 18. Light source device 401 includes first semiconductor laser element 10A, second semiconductor laser element 10B, third semiconductor laser element 10C, and light guide member 60 that is the light guiding unit.

Semiconductor laser elements 10A, 10B, and 10C oscillate the laser beams having different wavelengths. The wavelengths of the laser beams oscillated from semiconductor laser elements 10A, 10B, and 10C may be different from one another or substantially identical to one another. The laser beams oscillated from semiconductor laser elements 10A, 10B, and 10C may have the visible-region wavelengths.

The outer shape of light guide member 60 is formed into the substantially truncated pyramid shape. As used herein, the truncated pyramid shape means the shape in which a vertex portion of the circular cone or the polygonal pyramid such as the square pyramid is cut by the surface whose area is smaller than that of the bottom surface. Light guide member 60 is made of a material that is transparent with respect to the visible light. For example, when the visible-region laser beam is used, light guide member 60 is made of the optical glass (BK7) or resin having the transparency with respect to the visible light. For example, when the infrared laser beam is used, light guide member 60 is made of quartz. Light guide member 60 includes light incident surface 62 (bottom surface) and light outgoing surface 64 whose surface area is smaller than that of light incident surface 62.

Semiconductor laser elements 10A, 10B, and 10C are disposed close to the side of light incident surface 62 such that laser beams (11A, 11B, and 11C) oscillated from semiconductor laser elements 10A, 10B, and 10C are oriented toward the inside of light guide member 60.

First semiconductor laser element 10A may be disposed such that first laser beam 11A oscillated from first semiconductor laser element 10A is guided toward the side of light outgoing surface 64 from the side of light incident surface 62 while the total internal reflection of first laser beam 11A is repeated in light guide member 60.

Third semiconductor laser element 10C may be disposed such that third laser beam 11C oscillated from third semiconductor laser element 10C is guided toward the side of light outgoing surface 64 from the side of light incident surface 62 while the total internal reflection of third laser beam 11C is repeated in light guide member 60.

In FIG. 18, the optical axes of the laser beams are expressed by broken lines (11A to 11C). The broken lines (11A to 11C) schematically express optical axis directions of the laser beams and the state of the reflection in light guide member 60. Actually, each laser beam spreads with a predetermined radiation angle with respect to each of semiconductor laser elements 10A to 10C while centering around the optical axis, and the laser beams are emitted. Even if each laser beam is emitted while spreading, the total internal reflection of the laser beams including the spreading light beams is generated in light guide member 60, and the laser beam are collected to light outgoing surface 64. The same holds true for FIGS. 19 and 20.

A predetermined command is provided from the outside to each of semiconductor laser elements 10A, 10B, and 10C through lead wire 18, which allows semiconductor laser elements 10A, 10B, and 10C to independently oscillate the laser beams.

(Action and Effect)

The action and effect of light source device 401 of the seventeenth embodiment will be described below. In light source device 401, semiconductor laser elements 10A, 10B, and 10C individually oscillate the laser beams having arbitrary colors. Laser beams 11A, 11B, and 11C are guided toward light outgoing surface 64 while (totally internally) reflected in light guide member 60. The slope angle on the slope side of light guide member 60 may be designed such that laser beams 11A, 11B, and 11C are guided while totally internally reflected.

Because light source device 401 includes light guide member 60, the demand for attaching accuracy of semiconductor laser elements 10A, 10B, and 10C can be lowered. In other words, each laser beam can be collected in alignment free. Even if the vibration is generated in light source device 401 by the external factor, the alignment is hardly jolted out of or the breakage is hardly generated. According to light source device 401, the laser beams can easily be collected with the relatively low attaching accuracy and emitted as laser beam 31. Light source device 401 can be used as a simple collective optical element.

### Eighteenth Embodiment

A light source device 401a according to an eighteenth embodiment of the invention will be described with reference to FIG. 19. In the eighteenth embodiment, only a point different from light source device 401 of the seventeenth embodiment will be described. In light source device 401a, semiconductor laser elements 10A, 10B, and 10C are disposed such that all the optical axes of laser beams 11A, 11B, and 11C oscillated from semiconductor laser elements 10A, 10B, and 10C are oriented toward light outgoing surface 64. Preferably semiconductor laser elements 10A, 10B, and 10C are disposed such that all optical axes of laser beams 11A, 11B, and 11C oscillated from semiconductor laser elements 10A, 10B, and 10C are oriented toward the substantial center of light outgoing surface 64.

Laser beams 11A, 11B, and 11C are guided in light guide member 60 while all the optical axes of laser beams 11A, 11B, and 11C are oriented toward light outgoing surface 64. In light guide member 60, the laser beam emitted along the optical axis direction of each laser beam reaches the light outgoing surface with no reflection, and the laser beam that is obliquely output with respect to the optical axis direction of each laser beam reaches the light outgoing surface while the number of total internal reflection times is smaller than that in the light guide member. Therefore, the energy losses of laser beams 11A, 11B, and 11C can be suppressed.

### Nineteenth Embodiment

A light source device 402 according to a nineteenth embodiment of the invention will be described with reference to FIG. 20. Light source device 402 includes first semiconductor laser element 10A and light guide member 60 that is configured similarly to that of the seventeenth embodiment and eighteenth embodiment.

First semiconductor laser element 10A is disposed close to the side of light incident surface 62 such that first laser beam 11A oscillated from first semiconductor laser element 10A is oriented toward the inside of light guide member 60. First semiconductor laser element 10A may be disposed such that first laser beam 11A oscillated from first semiconductor laser element 10A is guided from the side of light incident surface 62 toward the side of light outgoing surface 64 while the total internal reflection is repeated in light guide member 60.

A predetermined command is provided from the outside to semiconductor laser element 10A through lead wire 18, which allows semiconductor laser element 10A to independently oscillate the laser beam.

In light source device 402, the laser beam oscillated from first semiconductor laser element 10A can also easily be collected with the relatively low attaching accuracy. Light source device 402 can be used as the simple collective optical element that outputs the collected laser beam 31.

Although the present invention has been described and illustrated in detail, it is clearly understood that the same is by way of illustration and example only and is not to be taken by way of limitation, the scope of the present invention being interpreted by the term of the appended claims.

What is claimed is:

1. A light source device comprising:
at least two semiconductor laser elements that oscillate laser beams having visible-region wavelengths; and
a light-scattering body that is irradiated with said laser beams to scatter said applied laser beams without changing the wavelengths,
wherein said laser beams oscillated from at least said two semiconductor laser elements have different colors.

2. The light source device according to claim 1, wherein said light-scattering body is directly irradiated with said laser beams oscillated from at least said two semiconductor laser elements.

3. The light source device according to claim 1, further comprising a package,
wherein at least said two semiconductor laser elements are mounted in said package, and
said light-scattering body is configured to be integral with said package.

4. The light source device according to claim 3, wherein said package includes a window portion,
a translucent member having translucency is attached to said window portion, and
said light-scattering body is disposed so as to come into close contact with said translucent member.

5. The light source device according to claim 1, wherein said laser beams oscillated from at least said two semiconductor laser elements are converted into parallel rays, and
said light-scattering body is irradiated with said parallel rays that are independent of each other.

6. The light source device according to claim 1, further comprising a combining member that combines said laser beams oscillated from at least said two semiconductor laser elements,
wherein said light-scattering body is irradiated with said laser beams with being mutually combined by said combining member.

7. The light source device according to claim 1, further comprising a light guiding unit that guides said laser beams oscillated from at least said two semiconductor laser elements to said light-scattering body and irradiates said light-scattering body with said guided laser beam.

8. The light source device according to claim 7, wherein said light guiding unit is an optical fiber.

9. The light source device according to claim 7, wherein an outer shape of said light guiding unit is formed into a substantially truncated pyramid,
said light guiding unit is a light guide member that includes a light incident surface and a light outgoing surface whose area is smaller than that of said light incident surface,
said light guide member is made of a material that is transparent with respect to visible light,
at least said two semiconductor laser elements are disposed on a side of said light incident surface, and
said light-scattering body is disposed on a side of said light outgoing surface.

10. The light source device according to claim 9, wherein at least said two semiconductor laser elements are disposed such that said laser beams oscillated from at least said two semiconductor laser elements are guided from the side of said light incident surface toward the side of said light outgoing surface while total internal reflection is repeated in said light guide member.

11. The light source device according to claim 9, wherein at least said two semiconductor laser elements are disposed such that optical axes of said laser beams oscillated from at least said two semiconductor laser elements are oriented toward said light-scattering body.

12. The light source device according to claim 9, wherein said light-scattering body is configured to be integral with said light guide member.

13. The light source device according to claim 1, wherein said light-scattering body includes a base material made of a transparent resin or glass material and transparent light-scattering particles that are dispersed in said base material, said transparent light-scattering particles having a refractive index different from that of said base material.

14. The light source device according to claim 1, wherein said laser beams that are scattered by said light-scattering body without changing the wavelengths are mixed to form white light.

15. The light source device according to claim 14, wherein at least said two semiconductor laser elements are at least three semiconductor laser elements in order to form said white light, and
at least said three semiconductor laser elements include:
said semiconductor laser element that oscillates said laser beam of blue;
said semiconductor laser element that oscillates said laser beam of red; and
said semiconductor laser element that oscillates said laser beam of green.

16. The light source device according to claim 14, wherein, in order to form said white light, at least said two semiconductor laser elements include:
said semiconductor laser element that oscillates said laser beam of yellow; and
said semiconductor laser element that oscillates said laser beam of blue.

17. The light source device according to claim 14, wherein, in order to form said white light, at least said two semiconductor laser elements include:
said semiconductor laser element that oscillates said laser beam of red; and
said semiconductor laser element that oscillates said laser beam of blue-green.

18. The light source device according to claim 1, further comprising a substantially-concave-shaped reflecting mirror that has a focal point,
wherein said light-scattering body is disposed at a position of said focal point.

19. The light source device according to claim 18, wherein said reflecting mirror includes an opening, and
said light-scattering body is irradiated with said laser beams oscillated from at least said two semiconductor laser elements through said opening.

20. A light source device comprising:
a light guide member whose outer shape is formed into a substantially truncated pyramid, said light guide member including a light incident surface and a light outgoing surface whose area is smaller than that of said light incident surface, said light guide member being made of a material that is transparent with respect to a laser beam; and
a semiconductor laser element that oscillates said laser beam, said laser beam being disposed such that said laser beam is oriented from a side of said light incident surface toward an inside of said light guide member,
wherein said laser beam oscillated from said semiconductor laser element is collected on a side of said light outgoing surface.

21. The light source device according to claim 20, wherein said semiconductor laser element is disposed such that said laser beam oscillated from said semiconductor laser element is guided from the side of said light incident surface toward the side of said light outgoing surface while total internal reflection is repeated in said light guide member.

22. The light source device according to claim 20, wherein said semiconductor laser element is disposed such that an optical axis of said laser beam oscillated from said semiconductor laser element is oriented toward said light outgoing surface.
